(19) United States
(12) Patent Application Publication
(10) Pub. No.: US 2024/0232725 A9
(43) Pub. Date: Jul. 11, 2024

(54) MACHINE LEARNING TECHNIQUES FOR REINFORCEMENT LEARNING USING CROSS-SUPPORT LIKELIHOOD MODEL SIMILARITY DETERMINATIONS

(71) Applicant: UnitedHealth Group Incorporated, Minnetonka, MN (US)

(72) Inventors: Reem A. Hussain, Silver Spring, MD (US); Yagnesh J. Patel, Edison, NJ (US); Vijay S. Nori, Roswell, GA (US)

(21) Appl. No.: 18/047,753

(22) Filed: Oct. 19, 2022

(51) Int. Cl. G06N 20/20

(52) U.S. Cl. CPC G06N 20/20

(57) ABSTRACT

Various embodiments of the present invention introduce technical advantages related to computational efficiency and storage efficiency of training reinforcement learning models using model-based reinforcement learning approaches. For example, various embodiments of the present invention enable training components of a dynamics model of a reinforcement learning framework using cross-space likelihood similarity measures between predicted transition likelihood models and empirical transition likelihood models even when the two noted likelihood models have distinct distribution supports. This enables using training/empirical observation data to train dynamics model components even when the output state spaces of the dynamics model components are distinct from the output state space of the empirical distributions determined using the training/empirical observation data.

### BACKGROUND

### Brief Summary

Various embodiments of the present invention utilize at least one of: (i) techniques for generating a likelihood similarity measure between two discrete likelihood models (i.e., two discrete probability distributions) that have distinct supports, and (ii) techniques for training a reinforcement learning machine learning framework by using the cross-support likelihood model similarity determinations techniques described in (i). However, while various embodiments of the present invention describe using the cross-support likelihood model similarity determinations techniques in the context of training a reinforcement learning machine learning framework, a person of ordinary skill in the relevant technology will recognize that the cross-support likelihood model similarity determinations techniques described herein can be used to perform other computational tasks.

In accordance with one aspect, a method is provided. In one embodiment, the method comprises: generating, using a reinforcement learning machine learning framework, the recommended reinforcement learning action, wherein: (i) the reinforcement learning machine learning framework is associated with an optimal reinforcement learning policy that is generated using an ensemble dynamics model, (ii) the ensemble dynamics model comprises a plurality of R dynamics model components, (iii) each dynamics model component is: (a) is associated with a respective input state of the S defined reinforcement learning states and a respective per-component output state space that describes a per-component output state subset of the S defined reinforcement learning states, (b) is configured to generate predicted state transition likelihood measures from the respective input state to the respective output state space, and (c) is generated based at least in part on a cross-space likelihood similarity measure between: (1) a respective predicted transition likelihood model that describes the predicted state transition likelihood measures generated by the dynamics model component with respect to the respective per-component output state space, and (2) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and (iv) each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and performing one or more prediction-based actions based at least in part on the recommended reinforcement learning action.

In accordance with another aspect, an apparatus comprising at least one processor and at least one memory, including computer program code, is provided. In one embodiment, the at least one memory and the computer program code may be configured to, with the processor, cause the apparatus to: generate, using a reinforcement learning machine learning framework, the recommended reinforcement learning action, wherein: (i) the reinforcement learning machine learning framework is associated with an optimal reinforcement learning policy that is generated using an ensemble dynamics model, (ii) the ensemble dynamics model comprises a plurality of R dynamics model components, (iii) each dynamics model component is: (a) is associated with a respective input state of the S defined reinforcement learning states and a respective per-component output state space that describes a per-component output state subset of the S defined reinforcement learning states, (b) is configured to generate predicted state transition likelihood measures from the respective input state to the respective output state space, and (c) is generated based at least in part on a cross-space likelihood similarity measure between: (1) a respective predicted transition likelihood model that describes the predicted state transition likelihood measures generated by the dynamics model component with respect to the respective per-component output state space, and (2) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and (iv) each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and perform one or more prediction-based actions based at least in part on the recommended reinforcement learning action.

In accordance with yet another aspect, a computer program product is provided. The computer program product may comprise at least one computer-readable storage medium having computer-readable program code portions stored therein, the computer-readable program code portions comprising executable portions configured to: generate, using a reinforcement learning machine learning framework, the recommended reinforcement learning action, wherein: (i) the reinforcement learning machine learning framework is associated with an optimal reinforcement learning policy that is generated using an ensemble dynamics model, (ii) the ensemble dynamics model comprises a plurality of R dynamics model components, (iii) each dynamics model component is: (a) is associated with a respective input state of the S defined reinforcement learning states and a respective per-component output state space that describes a per-component output state subset of the S defined reinforcement learning states, (b) is configured to generate predicted state transition likelihood measures from the respective input state to the respective output state space, and (c) is generated based at least in part on a cross-space likelihood similarity measure between: (1) a respective predicted transition likelihood model that describes the predicted state transition likelihood measures generated by the dynamics model component with respect to the respective per-component output state space, and (2) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and (iv) each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and perform one or more prediction-based actions based at least in part on the recommended reinforcement learning action.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating/training a reinforcement learning machine learning framework using an ensemble dynamics model that is generated based at least in part on cross-space likelihood similarity measures in accordance with some embodiments discussed herein.

FIG. 5 is a flowchart diagram of an example process for generating a dynamics model component using a cross-space likelihood similarity measure in accordance with some embodiments discussed herein.

FIG. 6 provides an operational example of a prediction output user interface in accordance with some embodiments discussed herein.

FIG. 7 is a data flow diagram of an example process for generating a cross-space likelihood similarity measure for two discrete likelihood models that have distinct supports in accordance with some embodiments discussed herein.

FIG. 8 provides an operational example of a predicted transition likelihood model for a dynamics model component and a corresponding empirical transition likelihood model in accordance with some embodiments discussed herein.

FIG. 9 provides an operational example of generating a cross-state correlation graph data object using a lowest-level hierarchical neighborhood definition level of a hierarchical neighborhood definition scheme in accordance with some embodiments discussed herein.

FIG. 10 provides an operational example of generating a cross-state correlation graph data object using a second-lowest-level hierarchical neighborhood definition level of a hierarchical neighborhood definition scheme in accordance with some embodiments discussed herein.

FIG. 11 provides an operational example of generating a cross-state correlation graph data object using a third-lowest-level hierarchical neighborhood definition level of a hierarchical neighborhood definition scheme in accordance with some embodiments discussed herein.

FIG. 12 provides an operational example of generating a cross-state correlation graph data object using a fourth-lowest-level hierarchical neighborhood definition level of a hierarchical neighborhood definition scheme in accordance with some embodiments discussed herein.

FIG. 13 provides an operational example of a cross-space state correlation graph data object in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Improvements

Provided herein are: (i) techniques for generating a likelihood similarity measure between two discrete likelihood models (i.e., two discrete probability distributions) that have distinct supports, and (ii) techniques for training a reinforcement learning machine learning framework by using the cross-support likelihood model similarity determinations techniques described in (i). However, while various embodiments of the present invention describe using the cross-support likelihood model similarity determinations techniques in the context of training a reinforcement learning machine learning framework, a person of ordinary skill in the relevant technology will recognize that the cross-support likelihood model similarity determinations techniques described herein can be used to perform other computational tasks. For example, in some embodiments, while selecting sampled/bootstrapped data from an original dataset, the likelihood model of the original dataset and the likelihood model of a particular sampled/bootstrapped dataset can be compared using the cross-support likelihood model similarity determinations techniques described herein to determine whether to accept or reject the particular sampled/bootstrapped dataset. In some embodiments, given a sampled/bootstrapped dataset that is selected from an original dataset using a sampling technique, a likelihood similarity measure for a discrete likelihood model of the sampled/bootstrapped dataset and a discrete likelihood model of the original dataset can be computed using the likelihood model similarity determinations techniques described herein. In some of the noted embodiments, the sampled/bootstrapped dataset can be rejected if the determined likelihood similarity measure fails to satisfy (e.g., fails to exceed) a likelihood similarity measure threshold (e.g., a likelihood similarity measure threshold of 0.5), while the sampled/bootstrapped dataset can be accepted if the determined likelihood similarity measure satisfies (e.g., exceeds) the likelihood similarity measure threshold.

Various embodiments of the present invention introduce technical advantages related to computational efficiency and storage efficiency of training reinforcement learning models using model-based reinforcement learning approaches. For example, various embodiments of the present invention enable training components of a dynamics model of a reinforcement learning framework using cross-space likelihood similarity measures (e.g., fuzzy distance measures) between predicted transition likelihood models and empirical transition likelihood models even when the two noted likelihood models have distinct distribution supports. This enables using training/empirical observation data to train dynamics model components even when the output state spaces of the dynamics model components are distinct from the output state space of the empirical distributions determined using the training/empirical observation data. In this way, various embodiments of the present invention reduce the amount of training/empirical observation data needed to train reinforcement learning models using model-based reinforcement learning approaches, a result that in turn improves computational efficiency and storage efficiency of training reinforcement learning models using model-based reinforcement learning approaches.

Various embodiments of the present invention enable generating, based at least in part on a neighborhood function, a similarity measure between a first distribution and a second distribution by: (i) generating a bipartite graph comprising a first disjoint set of nodes for the first distribution and a second disjoint set of nodes for the second distribution, where each node represents a state in the corresponding distribution; (ii) connecting each node of the first distribution to a source node and each node of the second distribution to a sink node; (iii) generating a plurality of edges, where each edge is associated with a first node from the first distribution and a second node from the second distribution having a qualifying neighborhood score; and (iv) generating a similarity score based at least in part on the maximum flow from the source node to the sink node.

Statistical distance between two probability distributions refers to how different two probability distributions are in terms of the corresponding random values and probabilities. One of the key components required when training intelligent agents using model-based reinforcement learning approach is a transition distribution function Pr[Sₜ₊₁=s′|Sₜ=s,Aₜ=a], where Sₜ is the state at time t, Aₜ is the action at time t. Accordingly, various embodiments of the present invention relate to determining the accuracy of a dynamics model in reinforcement learning frameworks (i.e., the statistical distance between the empirical distribution and predicted distribution returned by a dynamics model).

In some embodiments, the inputs to a proposed model to determine the fuzzy statistical distance include: (i) two discrete distributions D₁: {S₁₁:p₁₁:S₁₂:p₁₂, . . . , S₁ₘ:p₁ₘ} and D₂: {S₂₁:p₂₁,S₂₂:p₂₂, . . . , s₂ₙ:p₂ₙ} to be compared, where: Sᵢⱼ are the states (or general random variables), pᵢⱼ are the corresponding probabilities, and Σⱼ₌₁^{m}pᵢⱼ=1,Σⱼ₌₁ⁿpᵢⱼ=1; and (ii) the neighborhood function ƒ(Sᵢ,Sⱼ), which returns 1 if Sᵢ and Sⱼ are within a neighborhood, and 0 otherwise. In some embodiments, the neighborhood function can take in the states from both distributions and return a list of pairs of states which are in the same neighborhood.

In some embodiments, a bipartite graph is constructed, where the nodes on one side are states from D1 and nodes from the other side are states from D2. In some embodiments, constructing the graph comprises: (i) creating a source node and connecting all nodes which represent D1 to the source node, where the weights on the edges are the probabilities from D1, (ii) creating a sink node and connecting all nodes which represent D2 to the sink node, where the weights on the edges are the probabilities from D2, and (iii) connecting an edge between a node in D1 and a node in D2 if those nodes represent states for which the neighborhood function returns 1, where the edge weights for these edges are 1. In some embodiments, generating cross-distribution similarity includes computing the similarity score by solving maximum flow problem (i.e., Edmond-Karp's algorithm or Ford-Fulkerson algorithm) for flows between source and sink constrained by the edge weights, which serve as capacities on the edges. The maximum flow from source to sink (e.g., a number between 0 and 1) may be determined based at least in part on the similarity between the two distributions for the given neighborhood. In some embodiments, the similarity score may, optionally, be computed by performing the following steps (i.e., varying neighborhoods and weights): specifying N neighborhood functions, where each successive neighborhood wholly contains the one before but includes more pairs, specifying weights for each function, and computing the overall similarity score (SS) as (SSᵢ=0) using the equation SS=Σᵢ₌₁^{N}wᵢ(SSᵢ−SSᵢ₋₁), where the weights wᵢ are non-increasing in i.

### II. Definitions

The term “ensemble dynamics model” may refer to a data construct that describes parameters, hyperparameters, and/or defined operations of a dynamics/world model of a reinforcement learning environment that is an ensemble of a set of C dynamics model components, where each dynamics model component is configured to generate predicted transition likelihood measures from a respective input state of the S defined reinforcement learning states to a respective per-component output state space that describes a per-component output state subset of the S defined reinforcement learning states. In some embodiments, the ensemble dynamics model comprises an ensemble of C dynamics model components that collectively operate in accordance with an ensemble model-based reinforcement learning technique, such as in accordance with a Model-Ensemble Trust-Region Policy Optimization technique. Aspects of the Model-Ensemble Trust-Region Policy Optimization technique are described in Kurutach et al., Model-Ensemble Trust-Region Policy Optimization, arXiv:1802.10592 [cs.LG] (2018), available online at https://arxiv.org/abs/1802.10592. In some embodiments, the ensemble dynamics model comprises an ensemble of C dynamics model components that each generate a component of a transition probability distribution model/function, where the noted components are then combined to generate a global transition probability distribution model/function defined by the ensemble dynamics model.

The term “dynamics model component” may refer to a data construct that describes a component of an ensemble dynamics model that is configured to generate predicted transition probabilities from a respective input reinforcement learning state to output reinforcement learning states in a per-component output state space for the dynamics model component. In some embodiments, each dynamics model component is associated with: (i) a respective input state of the S defined reinforcement learning states, (ii) a respective reinforcement learning action that is selected from the set of defined reinforcement learning actions for the respective input state, and (iii) a respective per-component output state space that describes a subset of the S defined reinforcement learning states that are associated with the dynamics model component. In some of the noted embodiments, a dynamics model component may be configured to generate a respective predicted transition likelihood model that describes, for each defined reinforcement learning state in the respective per-component output state space of the dynamics model component, a predicted state transition likelihood measure, where the predicted state transition likelihood measure for a particular defined reinforcement learning may describe a predicted likelihood/probability that performing the respective reinforcement learning action for the dynamics model component at the respective input state for the respective reinforcement learning action causes a transition to the particular defined reinforcement learning state.

The term “predicted transition likelihood model” may refer to a data construct that describes a set of predicted transition likelihood measures for a respective dynamics model component, where each predicted transition likelihood measure describes a predicted/computed likelihood of transition to a respective output state in the per-component output state space for the respective dynamics model component if the respective reinforcement learning action for the respective dynamics model component is performed in the respective input state for the respective dynamics model. In some embodiments, the predicted/computed likelihoods of a predicted transition likelihood model are generated based at least in part on the output data of the respective dynamics model component for the particular transition likelihood model. Accordingly, in some embodiments, the predicted transition likelihood model for a particular dynamics model component describes a discrete probability distribution that describes, for each output state in the per-component output state space for the particular dynamics model component, a predicted/computed likelihood/probability that performing the action that is associated with the particular dynamics model component at the input state that is associated with the particular dynamics model component causes transition to the noted output state.

The term “empirical transition likelihood model” may refer to a data construct that describes a set of empirical state transition likelihood measures for a respective input reinforcement learning state and a respective reinforcement learning action that is selected from the set of reinforcement learning actions that are defined as being available for the respective input reinforcement learning state, where an empirical state transition likelihood measure describes a predicted/computed likelihood that performing the respective reinforcement learning action at the respective input reinforcement learning state causes a transition to a respective output reinforcement learning state in the empirical output state space for the empirical transition likelihood model as generated based at least in part on empirical observation data collected from a target reinforcement learning environment. In some embodiments, the empirical observation data for a reinforcement learning environment is processed to determine, for each output reinforcement learning state in a set of S defined reinforcement learning states, the relative/normalized frequency that performing a particular reinforcement learning action at a particular input reinforcement learning state of the S defined reinforcement learning state causes a transition from the particular input reinforcement learning state to the particular output reinforcement learning state. In some of the noted embodiments, if the relative/normalized frequency for a particular output reinforcement learning state with respect to a particular input reinforcement learning state and a particular reinforcement learning action satisfies (e.g., exceeds) a relative/normalized frequency threshold (e.g., a relative/normalized frequency threshold of zero), then the particular output reinforcement learning state is added to the empirical output state space for the empirical transition likelihood model that is associated with the particular input reinforcement learning state and the particular reinforcement learning action, and the relative/normalized frequencies for the output reinforcement learning states in the empirical output state space for the empirical transition likelihood model are then used (e.g., normalized) to generate the empirical transition likelihood model. Accordingly, in some embodiments, the empirical output state space for an empirical transition likelihood model is the support for the discrete probability distribution that is associated with the empirical transition likelihood model.

The term “cross-space likelihood similarity measure” may refer to a data construct that describes an estimated/computed/predicted similarity measure between a predicted transition likelihood model for a respective dynamics model component and an empirical transition likelihood model that describes empirical transition likelihood measures for transitions from the respective input state for the dynamics model component given performance of the respective reinforcement learning action for the dynamics model component, such as fuzzy distance measures. In some embodiments, the cross-space likelihood similarity measure for a dynamics model component describes a similarity measure between: (i) a discrete probability distribution described by the predicted transition likelihood model for the dynamics model component, and (ii) a discrete probability distribution described by an empirical transition likelihood model that describes empirical transition likelihood measures for transitions from the respective input state for the dynamics model component given performance of the respective reinforcement learning action for the dynamics model component. In some of the noted embodiments, because the discrete probability distribution associated with the predicted transition likelihood model is associated with a support (e.g., the respective per-component output state space for the dynamics model component) that may be distinct from the support for the discrete probability distribution associated with the empirical transition likelihood model (e.g., the respective empirical output state space for the respective input state space for the dynamics model component given performance of the respective reinforcement learning action for the dynamics model component), the cross-space likelihood similarity measure (which may be a similarity measure for the noted two discrete probability distributions) may be generated using the cross-support likelihood model similarity determinations techniques described herein, such as using the cross-support likelihood model similarity determinations techniques described in Subsection B of the present Section IV of the present document. However, a person of ordinary skill in the relevant technology will recognize that in some embodiments cross-space likelihood similarity measures may be generated using cross-support likelihood model similarity determinations techniques other than and/or in addition to the cross-support likelihood model similarity determinations techniques described herein.

The term “reinforcement learning machine learning framework” may refer to a data construct that describes parameters, hyperparameters, and/or defined operations of a machine/deep learning framework that is configured to, at each operational iteration/timestep, select a recommended reinforcement learning action from a set of available reinforcement learning actions for a computed/determined/given current reinforcement learning state. In some embodiments, each defined reinforcement learning state is associated with a set of reinforcement learning actions that an agent can perform when the agent is at the particular defined reinforcement learning state. Examples of reinforcement learning actions include medical procedure performances and/or medication prescriptions generations. In some embodiments, given a reinforcement learning environment state that is associated with a set of S defined reinforcement learning states and a set of reinforcement learning actions for each defined reinforcement learning state, the objective of a trained reinforcement learning machine learning framework is to, at each time: (i) detect a current reinforcement learning state of the reinforcement learning state based at least in part on environment monitoring data collected from the reinforcement learning environment, and (ii) generate a recommended action from the set of reinforcement learning actions associated with the current reinforcement learning state in accordance with a computed optimal reinforcement learning policy and/or a computed optimal reinforcement learning value model/function. In some of the noted embodiments, training the reinforcement learning machine learning framework comprises generating the computed optimal reinforcement learning policy and/or the computed optimal reinforcement learning value model/function. For example, using the model-based reinforcement learning approaches described herein that use simulated exploration data generated using a dynamics model of the reinforcement learning environment to generate the computed optimal reinforcement learning policy and/or the computed optimal reinforcement learning value model/function.

The term “cross-space state correlation graph data object” may refer to a data construct that describes a graph that is associated with two discrete likelihood models and that comprises: (i) a set of first-model nodes each associated with an output state in the output state space for the first discrete likelihood model, (ii) a set of second-model nodes each associated with an output state in the output state space for the second discrete likelihood model, and (iii) for each node pair that comprises a first-model node and a second-model node, a cross-node link indicator that indicates whether a pairwise neighborhood score for the output state of the first-model node in the node pair and the output state of the second-model node in the node pair satisfies a pairwise neighborhood score condition. In some embodiments, a cross-space state correlation graph data object for two discrete likelihood models comprises: (i) a source node, (ii) a sink node, (iii) a set of N₁ first-model nodes each associated with an output state in the N₁-sized output state space for the first discrete likelihood model, (iv) a set of N₂ second-model nodes each associated with an output state in the N₂-sized output state space for the second discrete likelihood model, (v) a set of N₁ source links each being a graph link/edge from the source node to a respective one of the N₁ first-model nodes, (vi) a set of N₂ sink links each being a graph link/edge from a respective one of the N₂ second-model nodes to the sink mode, and (vii) for each node pair comprising a first-model node and a second-model node and that is associated with an affirmative cross-link indicator (which indicates that the a pairwise neighborhood score for the output state of the first-model node in the node pair and the output state of the second-model node in the node pair satisfies a pairwise neighborhood score condition), a cross-node link/edge from the first-model node in the pair to the second-model node in the node pair.

The term “cross-state neighborhood definition model” may refer to a data construct that defines, for each state pair associated with output state spaces of a set of discrete likelihood models, a pairwise neighborhood score that describes whether and/or how much the output state pair are deemed to be neighboring/related output states. For example, when a set of discrete likelihood models correspond to discrete transition likelihood models for a dynamics model of a reinforcement learning machine learning framework, the state pairs may correspond to pairs of reinforcement learning states from the S reinforcement learning states associated with a reinforcement learning environment of the reinforcement learning machine learning frameworks. In the described example, the pairwise neighborhood scores for a state pair may describe whether and/or how much the two reinforcement learning states in the state pair are deemed to be neighboring/related reinforcement learning spaces. For example, in some embodiments, given two output states (e.g., reinforcement learning states) in a state pair, the state pair is assigned a first (e.g., a lowest) pairwise neighborhood score if the state representations (e.g., state representation vectors) for the two output states are identical. For example, if a state pair comprises a first output state space with the state representation (1, 2, 3) and a second output state space with the state representation (1, 2, 3), then the state pair may be assigned a lowest pairwise neighborhood score, such as a pairwise neighborhood score of one. As another example, in some embodiments, given two output state spaces in a state pair, the state pair is assigned a second (e.g., a second-lowest) pairwise neighborhood score if the state representations for the two output state spaces differ in one value and the difference is by one. For example, if a state pair comprises a first output state space with the state representation (1, 2, 3) and a second output state space with the state representation (1, 1, 3), then the state pair may be assigned a second-lowest pairwise neighborhood score, such as a pairwise neighborhood score of two, as the two state representations differ in one value (i.e., the second value) and the difference is by one (i.e., 2−1=1). In some embodiments, the cross-state neighborhood definition model defines a pairwise neighborhood score for each state pair (e.g., each state pair associated with two reinforcement learning states of a reinforcement learning environment for a reinforcement learning machine learning framework). In some embodiments, the cross-state neighborhood definition model defines a set of state pairs that have a non-zero pairwise neighborhood score. In some embodiments, the pairwise neighborhood score is a binary/Boolean variable, while in other embodiments the pairwise neighborhood score can have three or more values.

The term “pairwise neighborhood score condition” may refer to a data condition that, when satisfied by the pairwise neighborhood score for a given state pair, causes addition of a cross-node link between the node pair associated with the given state pair in a cross-space state correlation graph data object that is associated with the pairwise neighborhood score condition. For example, consider an exemplary environment characterized by: (i) a predicted transition likelihood model for a dynamics model component whose respective per-component output state space comprises the reinforcement learning state with the state representation (1, 2, 3), the reinforcement learning state with the state representation (1, 3, 3), and the reinforcement learning state with the state representation (4, 2, 3), (ii) an empirical transition likelihood model whose respective empirical output state space comprises the reinforcement learning state with the state representation (1, 2, 3), the reinforcement learning state with the state representation (1, 3, 4), and the reinforcement learning state with the state representation (4, 4, 3), (iii) a first pairwise neighborhood score condition that is satisfied when the pairwise neighborhood score for a given state pair is one, and (iv) a second pairwise neighborhood score condition that is satisfied when the pairwise neighborhood score for the given state pair is one or two. In this example, for the first pairwise neighborhood score condition, a first cross-space state correlation graph data object may be generated that may include: (i) a source node, (ii) a sink node, (iii) source links from the source node to each of the reinforcement learning state with the state representation (1, 2, 3), the reinforcement learning state with the state representation (1, 3, 3), and the reinforcement learning state with the state representation (4, 2, 3), (iv) sink links from each of the reinforcement learning state with the state representation (1, 2, 3), the reinforcement learning state with the state representation (1, 3, 4), and the reinforcement learning state with the state representation (4, 4, 3) to the sink node, and (v) a sole cross-node link/edge from the reinforcement learning state with the state representation (1, 2, 3) and the reinforcement learning state with the state representation (1, 2, 3), as the two reinforcement learning states have identical state representations and thus can be assigned a pairwise neighborhood score of one in accordance with the exemplary scoring logic described above. Moreover, given the described example, for the second pairwise neighborhood score condition, a second cross-space state correlation graph data object may be generated that may include: (i) a source node, (ii) a sink node, (iii) source links from the source node to each of the reinforcement learning state with the state representation (1, 2, 3), the reinforcement learning state with the state representation (1, 3, 3), and the reinforcement learning state with the state representation (4, 2, 3), (iv) sink links from each of the reinforcement learning state with the state representation (1, 2, 3), the reinforcement learning state with the state representation (1, 3, 4), and the reinforcement learning state with the state representation (4, 4, 3) to the sink node, (iv) a first cross-node link/edge from the reinforcement learning state with the state representation (1, 2, 3) and the reinforcement learning state with the state representation (1, 2, 3), as the two reinforcement learning states have identical state representations and thus can be assigned a pairwise neighborhood score of one in accordance with the exemplary scoring logic described above, and (v) a second cross-node link/edge from the reinforcement learning state with the state representation (1, 3, 3) and the reinforcement learning state with the state representation (1, 3, 4), as the two state representations differ in one value and by one, and thus can be assigned a pairwise neighborhood score of two in accordance with the exemplary scoring logic described above.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DEVIM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

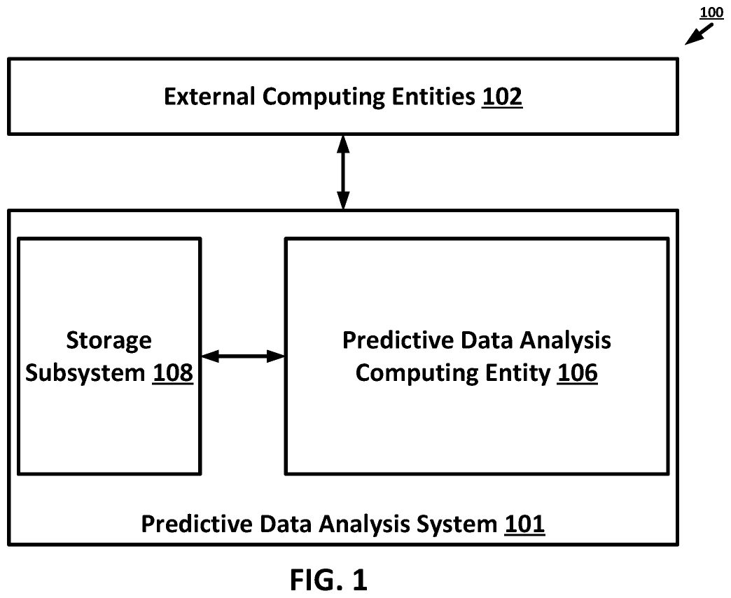

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions. An example of a prediction-based action that can be performed using the predictive data analysis system 101 is a request for generating a recommended action given a reinforcement learning state.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

A. Exemplary Predictive Data Analysis Computing Entity

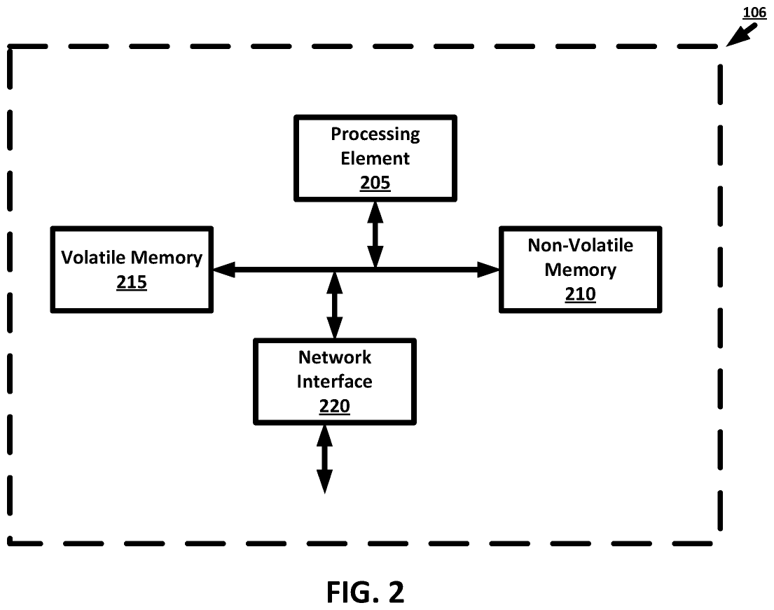

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

B. Exemplary Client Computing Entity

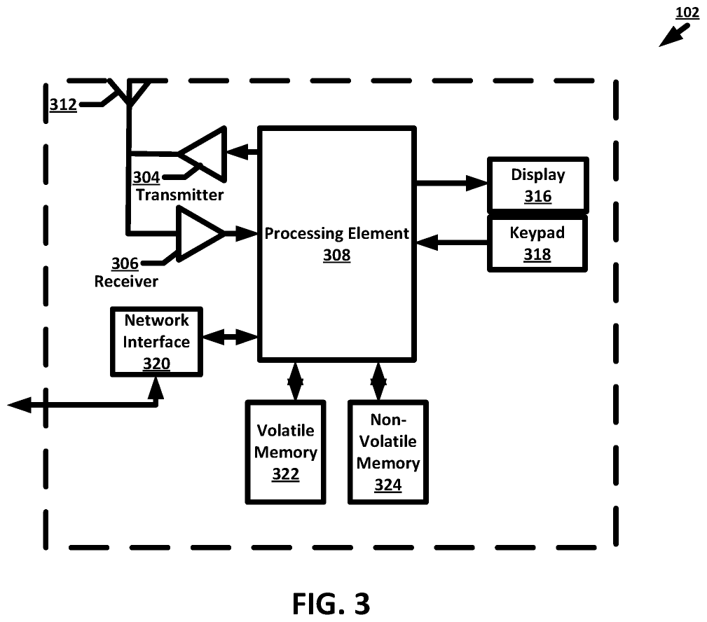

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Provided herein are: (i) techniques for generating a likelihood similarity measure between two discrete likelihood models (i.e., two discrete probability distributions) that have distinct supports, and (ii) techniques for training a reinforcement learning machine learning framework by using the cross-support likelihood model similarity determinations techniques described in (i). However, while various embodiments of the present invention describe using the cross-support likelihood model similarity determinations techniques in the context of training a reinforcement learning machine learning framework, a person of ordinary skill in the relevant technology will recognize that the cross-support likelihood model similarity determinations techniques described herein can be used to perform other computational tasks. For example, in some embodiments, while selecting sampled/bootstrapped data from an original dataset, the likelihood model of the original dataset and the likelihood model of a particular sampled/bootstrapped dataset can be compared using the cross-support likelihood model similarity determinations techniques described herein to determine whether to accept or reject the particular sampled/bootstrapped dataset. In some embodiments, given a sampled/bootstrapped dataset that is selected from an original dataset using a sampling technique, a likelihood similarity measure for a discrete likelihood model of the sampled/bootstrapped dataset and a discrete likelihood model of the original dataset can be computed using the likelihood model similarity determinations techniques described herein. In some of the noted embodiments, the sampled/bootstrapped dataset can be rejected if the determined likelihood similarity measure fails to satisfy (e.g., fails to exceed) a likelihood similarity measure threshold (e.g., a likelihood similarity measure threshold of 0.5), while the sampled/bootstrapped dataset can be accepted if the determined likelihood similarity measure satisfies (e.g., exceeds) the likelihood similarity measure threshold.

A. Reinforcement Learning Techniques

As described below, various embodiments of the present invention introduce technical advantages related to computational efficiency and storage efficiency of training reinforcement learning models using model-based reinforcement learning approaches. For example, various embodiments of the present invention enable training components of a dynamics model of a reinforcement learning framework using cross-space likelihood similarity measures between predicted transition likelihood models and empirical transition likelihood models even when the two noted likelihood models have distinct distribution supports. This enables using training/empirical observation data to train dynamics model components even when the output state spaces of the dynamics model components are distinct from the output state space of the empirical distributions determined using the training/empirical observation data. In this way, various embodiments of the present invention reduce the amount of training/empirical observation data needed to train reinforcement learning models using model-based reinforcement learning approaches, a result that in turn improves computational efficiency and storage efficiency of training reinforcement learning models using model-based reinforcement learning approaches.

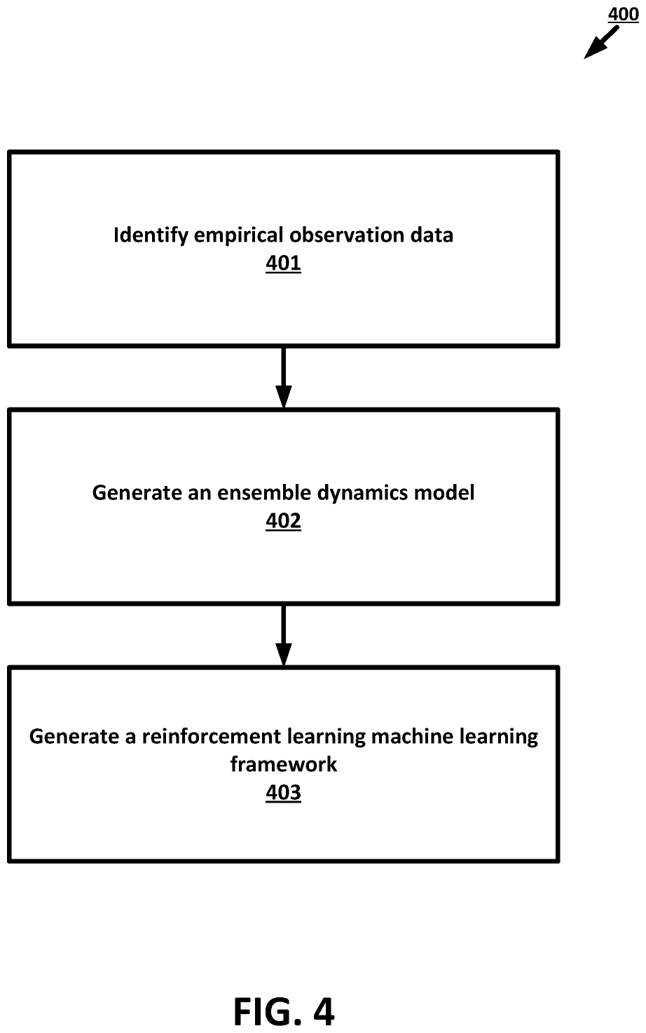

FIG. 4 is a flowchart diagram of an example process 400 for generating/training a reinforcement learning machine learning framework using an ensemble dynamics model that is generated based at least in part on cross-space likelihood similarity measures determined using cross-support likelihood model similarity determinations. Using the various steps/operations of the process 400, the predictive data analysis computing entity 106 can generate/train a reinforcement learning machine learning framework that is associated with a large state space by using less empirical observation data recorded by monitoring/observing an environment of the reinforcement learning machine learning framework.

The process 400 begins at step/operation 401 when the predictive data analysis computing entity 106 identifies (e.g., receives, retrieves, and/or the likes) empirical observation data collected from a respective reinforcement learning environment. The empirical observation data may describe a set of training entries, where each training entry describes a recorded observation that performing a particular reinforcement learning action at a particular current reinforcement learning state has caused a transition from the particular current reinforcement learning state to a respective subsequent reinforcement learning state. Accordingly, in some embodiments, each training entry may be represented by the triplet (sₜ, aₜ, sₜ₊₁), where sₜ is the particular current reinforcement learning state, at is the particular reinforcement learning action, and sₜ₊₁ is the particular subsequent reinforcement learning state.

In some embodiments, both the current reinforcement learning state described by a training entry and the subsequent reinforcement learning state described by a training entry are selected from a set of S defined reinforcement learning states associated with the reinforcement learning environment of the reinforcement learning machine learning framework. For example, in some embodiments, the set of S defined reinforcement learning states comprise at least one of: (i) a set of disease/condition-describing states that describe a code for a particular disease/condition and a severity indicator (e.g., a numerical severity indicator selected from a numerical severity indicator range, such as the numerical severity indicator range {1, 2, 3, 4}) for the particular disease/condition, and (ii) a set of utilization-category-describing states that describe a code for a particular utilization element and a status/feature indicator (e.g., a numerical status/feature indicator selected from a numerical status/feature indicator range, such as the numerical status/feature indicator range {1, 2, 3, 4}) for the particular utilization element.

In some embodiments, each defined reinforcement learning state is an ordered set of values, where each value in the ordered set describes a feature of an entity/concept described by the preceding values in the ordered set. For example, in some embodiments, each defined reinforcement learning state is associated with three values, where the first value describes a disease/condition category or a utilization category, the second value describes a disease/condition or a utilization level, and the third value describes a numerical severity indicator of a disease/condition or a numerical statues/feature indicator of a utilization element. Examples of defined reinforcement learning states having the described format include DM1 for diabetes mellitus severity level 1, ED1 for emergency department utilization level 1, and/or the like.

In some embodiments, each defined reinforcement learning state is associated with a set of reinforcement learning actions that an agent can perform when the agent is at the particular defined reinforcement learning state. Examples of reinforcement learning actions include medical procedure performances and/or medication prescriptions generations. In some embodiments, given a reinforcement learning environment state that is associated with a set of S defined reinforcement learning states and a set of reinforcement learning actions for each defined reinforcement learning state, the objective of a trained reinforcement learning machine learning framework is to, at each time: (i) detect a current reinforcement learning state of the reinforcement learning state based at least in part on environment monitoring data collected from the reinforcement learning environment, and (ii) generate a recommended action from the set of reinforcement learning actions associated with the current reinforcement learning state in accordance with a computed optimal reinforcement learning policy and/or a computed optimal reinforcement learning value model/function. In some of the noted embodiments, training the reinforcement learning machine learning framework comprises generating the computed optimal reinforcement learning policy and/or the computed optimal reinforcement learning value model/function, for example using the model-based reinforcement learning approaches described herein that use simulated exploration data generated using a dynamics model of the reinforcement learning environment to generate the computed optimal reinforcement learning policy and/or the computed optimal reinforcement learning value model/function.

At step/operation 402, the predictive data analysis computing entity 106 generates an ensemble dynamics model for the reinforcement learning machine learning framework based at least in part on the empirical observation data. The ensemble dynamics model may include a set of C dynamics model components, where each dynamics model component is configured to generate predicted transition likelihood measures from a respective input state of the S defined reinforcement learning states to a respective per-component output state space that describes a per-component output state subset of the S defined reinforcement learning states. In some embodiments, each dynamics model component is associated with: (i) a respective input state of the S defined reinforcement learning states, (ii) a respective reinforcement learning action that is selected from the set of defined reinforcement learning actions for the respective input state, and (iii) a respective per-component output state space that describes a subset of the S defined reinforcement learning states that are associated with the dynamics model component. In some of the noted embodiments, a dynamics model component may be configured to generate a respective predicted transition likelihood model that describes, for each defined reinforcement learning state in the respective per-component output state space of the dynamics model component, a predicted state transition likelihood measure, where the predicted state transition likelihood measure for a particular defined reinforcement learning may describe a predicted likelihood/probability that performing the respective reinforcement learning action for the dynamics model component at the respective input state for the respective reinforcement learning action causes a transition to the particular defined reinforcement learning state.

For example, consider a particular dynamics model component that is associated with the respective input state s₁ with a set of reinforcement learning actions A₁, the respective reinforcement learning action a₁ that is selected from A₁, and the respective per-component output state space {s₂, s₃, s₄, s₅}. In this example, the particular dynamics model component is associated with a respective predicted transition likelihood model that describes the following four predicted state transition likelihood measures: (i) a first predicted state transition likelihood measure that describes the predicted likelihood/probability that performing a₁ at s₁ causes a transition to 0.52, (ii) a second predicted state transition likelihood measure that describes the predicted likelihood/probability that performing a₁ at s₁ causes a transition to s₃, (iii) a third predicted state transition likelihood measure that describes the predicted likelihood/probability that performing a₁ at s₁ causes a transition to s₄, and (iv) a fourth predicted state transition likelihood measure that describes the predicted likelihood/probability that performing a₁ at s₁ causes a transition to s₄. As this example illustrates, each dynamics model component may be associated with a respective discrete probability distribution across a support (i.e., a range of defined/covered random variable values) that is defined by the respective per-component output state space for the dynamics model component. For example, in the described example, the described dynamics model component is associated with a discrete probability distribution P(S|s₁, a₁) whose support is described by the respective per-component output state space {s₂, s₃, s₄, s₅}.

As described above, in some embodiments, an ensemble dynamics model for a reinforcement learning environment of a reinforcement learning machine learning framework comprises an ensemble of C dynamics model components. For example, in some embodiments, the ensemble dynamics model comprises an ensemble of C dynamics model components that collectively operate in accordance with an ensemble model-based reinforcement learning technique, such as in accordance with a Model-Ensemble Trust-Region Policy Optimization technique. Aspects of the Model-Ensemble Trust-Region Policy Optimization technique are described in Kurutach et al., Model-Ensemble Trust-Region Policy Optimization, arXiv:1802.10592 [cs.LG] (2018), available online at https://arxiv.org/abs/1802.10592. As another example, in some embodiments, the ensemble dynamics model comprises an ensemble of C dynamics model components that each generate a component of a transition probability distribution model/function, where the noted components are then combined to generate a global transition probability distribution model/function defined by the ensemble dynamics model.

Accordingly, in some embodiments, generating/training an ensemble dynamics model comprises generating/training the C dynamics model components of the noted ensemble dynamics model. For example, in some embodiments, a dynamics model component is generated based at least in part on a cross-space likelihood similarity measure between: (a) a respective predicted transition likelihood model that describes the predicted state transition likelihood measures generated by the dynamics model component with respect to the respective per-component output state space, and (b) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment. For example, in some embodiments, a dynamics model component is generated based at least in part on an error/loss function/model that relates parameters of the dynamics model component to a cross-space likelihood similarity measure between: (a) a respective predicted transition likelihood model that describes the predicted state transition likelihood measures generated by the dynamics model component with respect to the respective per-component output state space, and (b) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment.

As described above, a cth dynamics model component that is associated with a respective input state s_{i,c}, a respective reinforcement learning action a_{c}, and a per-component output state space S_{o,c}={S_{o,c,1} . . . S_{o,c,n(c)}} may be associated with a respective predicted transition likelihood model that is a discrete probability distribution across a support defined by S_{o,c}, where the discrete probability distribution describes n(c) likelihood/probability values (referred to herein as n(c) predicted state transition likelihood measures), and where each likelihood/probability value is associated with a respective state in S_{o,c} and describes a predicted/computed likelihood (as generated based at least in part on the output of the cth dynamics model component) that performing a_{c} at s_{i,c} causes a transition to the respective state in S_{o,c}. In some of the noted embodiments, the transitions described by the empirical observation data can be used to generate an empirical transition likelihood model that is a discrete probability distribution across a support defined by an empirical output state space S_{e,c}={S_{e,c,1} . . . S_{e,c,n(ec)}}, where the discrete probability distribution describes n(ec) likelihood/probability values (referred to herein as n(ec) empirical state transition likelihood measures), and where each likelihood/probability value is associated with a respective state in Sₑ and describes an observed likelihood (as generated based at least in part on frequencies of transitions described by the empirical observation data) that that performing a_{c} at s_{i,c} causes a transition to the respective state in S_{e,c}. Importantly, while both the predicted transition likelihood model and the empirical transition likelihood model are associated with the respective same input state and the same respective reinforcement learning action, they are associated with supports that can be distinct (i.e., S_{o,c} may be distinct from S_{e,c}). Accordingly, in some embodiments, the cross-space likelihood similarity measure may be generated using the cross-support likelihood model similarity determinations techniques described herein. For example, in some embodiments, a particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score (e.g., to determine a fuzzy match).

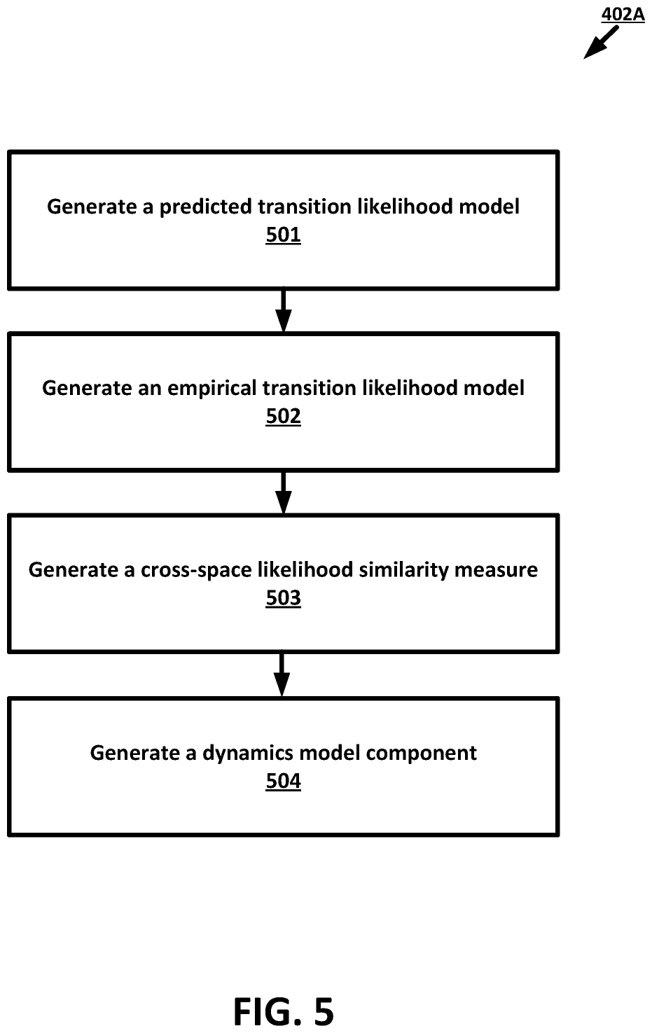

In some embodiments, generating a particular dynamics model component that is associated with a particular input state, a particular reinforcement learning state, and a particular per-component action state space is performed in accordance with the process 402A that is depicted in FIG. 5. As depicted in FIG. 5, the process 500 begins at step/operation 501 when the predictive data analysis computing entity 106 generates the respective predicted transition likelihood model for the particular dynamics model component that describes the predicted state transition likelihood measures generated by the dynamics model component with respect to the particular per-component output state space.

In some embodiments, a predicted transition likelihood model describes a set of predicted transition likelihood measures for a respective dynamics model component, where each predicted transition likelihood measure describes a predicted/computed likelihood of transition to a respective output state in the per-component output state space for the respective dynamics model component if the respective reinforcement learning action for the respective dynamics model component is performed in the respective input state for the respective dynamics model. In some embodiments, the predicted/computed likelihoods of a predicted transition likelihood model are generated based at least in part on the output data of the respective dynamics model component for the particular transition likelihood model. Accordingly, in some embodiments, the predicted transition likelihood model for a particular dynamics model component describes a discrete probability distribution that describes, for each output state in the per-component output state space for the particular dynamics model component, a predicted/computed likelihood/probability that performing the action that is associated with the particular dynamics model component at the input state that is associated with the particular dynamics model component causes transition to the noted output state.

At step/operation 502, the predictive data analysis computing entity 106 generates the respective empirical transition likelihood model that describes empirical state transition likelihood measures for transitions from the particular input state given the particular reinforcement learning action as generated based at least in part on the empirical observation data. In some embodiments, an empirical transition likelihood model describes a set of empirical state transition likelihood measures for a respective input reinforcement learning state and a respective reinforcement learning action that is selected from the set of reinforcement learning actions that are defined as being available for the respective input reinforcement learning state, where an empirical state transition likelihood measure describes a predicted/computed likelihood that performing the respective reinforcement learning action at the respective input reinforcement learning state causes a transition to a respective output reinforcement learning state in the empirical output state space for the empirical transition likelihood model as generated based at least in part on empirical observation data collected from a target reinforcement learning environment.

In some embodiments, the empirical observation data for a reinforcement learning environment is processed to determine, for each output reinforcement learning state in a set of S defined reinforcement learning states, the relative/normalized frequency that performing a particular reinforcement learning action at a particular input reinforcement learning state of the S defined reinforcement learning state causes a transition from the particular input reinforcement learning state to the particular output reinforcement learning state. In some of the noted embodiments, if the relative/normalized frequency for a particular output reinforcement learning state with respect to a particular input reinforcement learning state and a particular reinforcement learning action satisfies (e.g., exceeds) a relative/normalized frequency threshold (e.g., a relative/normalized frequency threshold of zero), then the particular output reinforcement learning state is added to the empirical output state space for the empirical transition likelihood model that is associated with the particular input reinforcement learning state and the particular reinforcement learning action, and the relative/normalized frequencies for the output reinforcement learning states in the empirical output state space for the empirical transition likelihood model are then used (e.g., normalized) to generate the empirical transition likelihood model. Accordingly, in some embodiments, the empirical output state space for an empirical transition likelihood model is the support for the discrete probability distribution that is associated with the empirical transition likelihood model.

At step/operation 503, the predictive data analysis computing entity 106 generates a cross-space likelihood similarity measure for the particular dynamics model component. In some embodiments, the cross-space likelihood similarity measure for a dynamics model component describes a similarity measure between a predicted transition likelihood model for the dynamics model component and an empirical transition likelihood model that describes empirical transition likelihood measures for transitions from the respective input state for the dynamics model component given performance of the respective reinforcement learning action for the dynamics model component. In some embodiments, the cross-space likelihood similarity measure for a dynamics model component describes a similarity measure between: (i) a discrete probability distribution described by the predicted transition likelihood model for the dynamics model component, and (ii) a discrete probability distribution described by an empirical transition likelihood model that describes empirical transition likelihood measures for transitions from the respective input state for the dynamics model component given performance of the respective reinforcement learning action for the dynamics model component. In some of the noted embodiments, because the discrete probability distribution associated with the predicted transition likelihood model is associated with a support (e.g., the respective per-component output state space for the dynamics model component) that may be distinct from the support for the discrete probability distribution associated with the empirical transition likelihood model (e.g., the respective empirical output state space for the respective input state space for the dynamics model component given performance of the respective reinforcement learning action for the dynamics model component), the cross-space likelihood similarity measure (which may be a similarity measure for the noted two discrete probability distributions) may be generated using the cross-support likelihood model similarity determinations techniques described herein, such as using the cross-support likelihood model similarity determinations techniques described in Subsection B of the present Section IV of the present document. However, a person of ordinary skill in the relevant technology will recognize that in some embodiments cross-space likelihood similarity measures may be generated using cross-support likelihood model similarity determinations techniques other than and/or in addition to the cross-support likelihood model similarity determinations techniques described herein.

At step/operation 504, the predictive data analysis computing entity 106 generates the particular dynamics model component based at least in part on the cross-space likelihood similarity measure. In some embodiments, the predictive data analysis computing entity 106 updates parameters of the particular dynamics model component in order to optimize a loss/error function/model that is generated based at least in part on the cross-space likelihood measure. For example, in some embodiments, because different combinations of parameter values for parameters of a dynamics model component generate different predicted transition likelihood models for the dynamics model component, and further because different predicted transition likelihood models generate different cross-space likelihood similarity measures and thus different loss/error measures, the relationship between parameter value combinations and resulting loss/error measures as generated based at least in part on cross-space likelihood similarity measures can be used to generate a loss/error function/model, and the parameter value combinations that optimize (e.g., locally optimize, globally optimize, and/or the like) loss/error function/model can then be used to generate/train the particular dynamics model component.

Returning to FIG. 4, at step/operation 403, the predictive data analysis computing entity 106 generates the reinforcement learning machine learning framework based at least in part on the ensemble dynamics model. In some embodiments, once generated/trained, the ensemble dynamics model is then used to generate simulated observational data that enables generating simulated trajectories, determining transition reward measures for the simulated trajectories, and generating at least one of a computed optimal reinforcement learning policy and/or a computed optimal reinforcement learning value model/function based at least in part on the transition reward measures. Once generated/trained, the reinforcement learning machine learning framework may be configured to, given a current reinforcement learning state, select a recommended reinforcement learning action from the set of recommended reinforcement learning actions that are defined as being available in the current reinforcement learning state, where the noted selection is performed in a manner that is configured to optimize a future expected reward value.

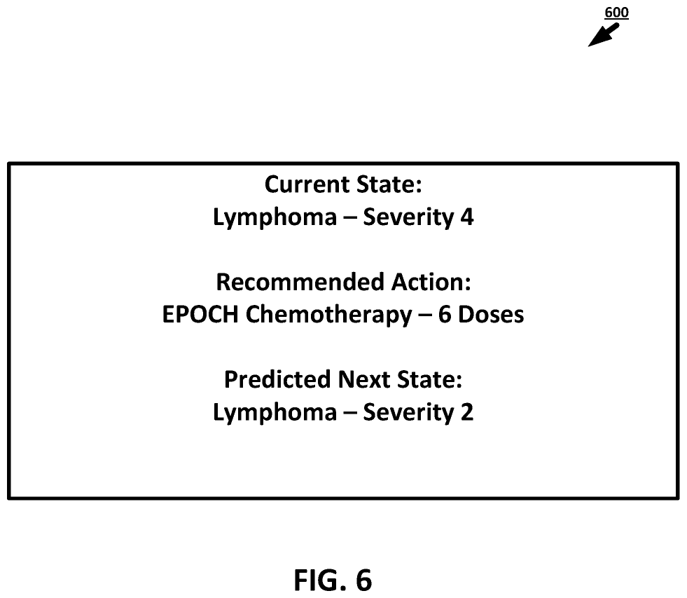

Accordingly, the reinforcement learning machine learning framework may be configured to, at each operational iteration/timestep, select a recommended reinforcement learning action from a set of available reinforcement learning actions for a computed/determined/given current reinforcement learning state. In some embodiments, the recommended reinforcement learning action that is generated by the reinforcement learning machine learning framework may be used to perform one or more prediction-based actions. Examples of prediction-based actions include performing automated operations corresponding to recommended action, generating audiovisual notifications corresponding to recommended action, performing operational load balancing operations for intervention servers that are configured to perform operations corresponding to recommended action, and/or the like. In some embodiments, performing the prediction-based actions comprises generating user interface data for a prediction output user interface that is configured to describe a recommended action and an expected subsequent state that results from performing the recommended action. An operational example of such a prediction output user interface 600 is depicted in FIG. 6.

Accordingly, as described above, various embodiments of the present invention introduce technical advantages related to computational efficiency and storage efficiency of training reinforcement learning models using model-based reinforcement learning approaches. For example, various embodiments of the present invention enable training components of a dynamics model of a reinforcement learning framework using cross-space likelihood similarity measures between predicted transition likelihood models and empirical transition likelihood models even when the two noted likelihood models have distinct distribution supports. This enables using training/empirical observation data to train dynamics model components even when the output state spaces of the dynamics model components are distinct from the output state space of the empirical distributions determined using the training/empirical observation data. In this way, various embodiments of the present invention reduce the amount of training/empirical observation data needed to train reinforcement learning models using model-based reinforcement learning approaches, a result that in turn improves computational efficiency and storage efficiency of training reinforcement learning models using model-based reinforcement learning approaches.

B. Cross-Support Likelihood Model Similarity Determination Techniques

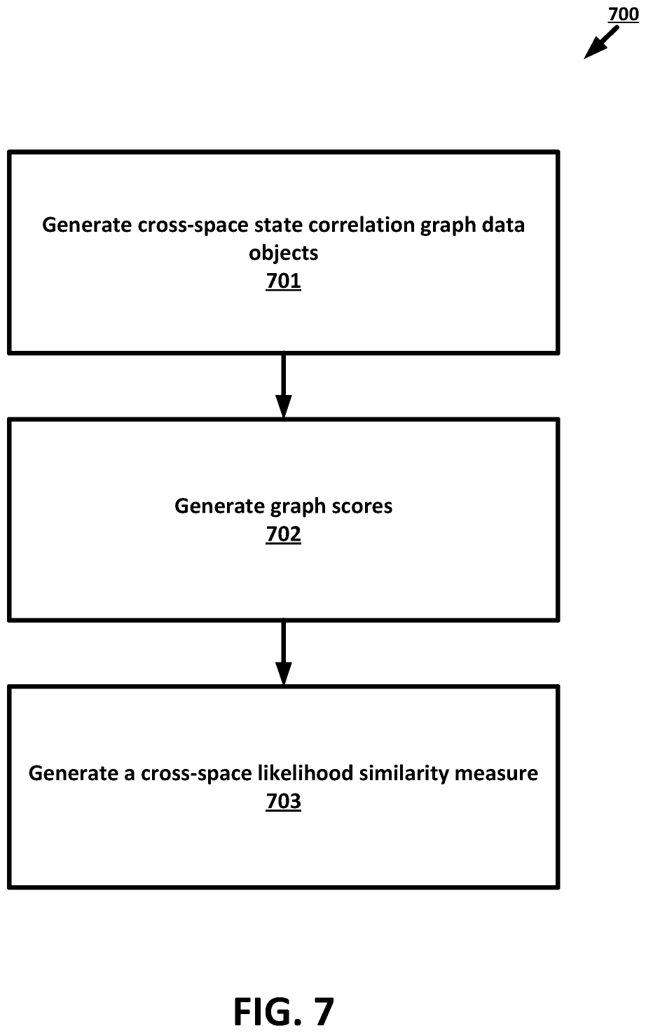

FIG. 7 is a flowchart diagram of an example process for generating a cross-space likelihood similarity measure for two discrete likelihood models that have distinct supports, such as for a predicted transition likelihood model for a dynamics model component whose support is a per-component output state space for the dynamics model component and an empirical transition likelihood model whose support is an empirical output state space that may be distinct from the per-component output state space for the dynamics model component. However, while various embodiments of the present invention describe using the cross-support likelihood model similarity determinations techniques in the context of training a reinforcement learning machine learning framework, a person of ordinary skill in the relevant technology will recognize that the cross-support likelihood model similarity determinations techniques described herein can be used to perform other computational tasks. For example, in some embodiments, while selecting sampled/bootstrapped data from an original dataset, the likelihood model of the original dataset and the likelihood model of a particular sampled/bootstrapped dataset can be compared using the cross-support likelihood model similarity determinations techniques described herein to determine whether to accept or reject the particular sampled/bootstrapped dataset.

In some embodiments, a discrete likelihood model is a discrete probability distribution having a support that describes the set of random variable values whose respective probability/likelihood values are described by the discrete probability distribution. In some of the noted embodiments, each random variable value in the support for a discrete probability distribution that is associated with a discrete likelihood model is referred to as an output state of the discrete likelihood model, while the support for the discrete probability distribution that is associated with a discrete likelihood model is referred to as the output state space for the discrete likelihood model.

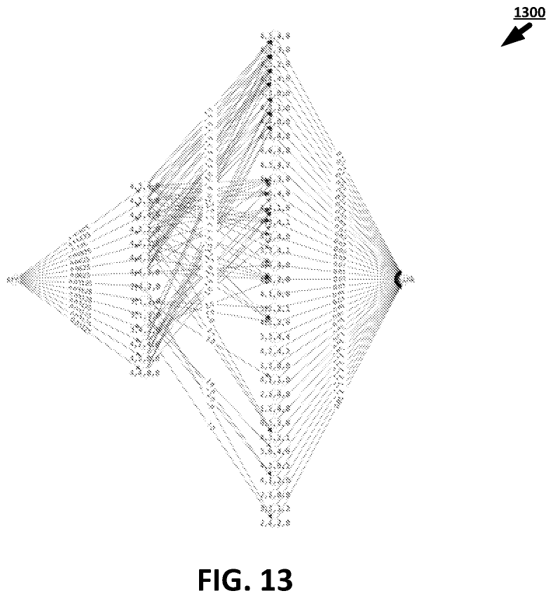

The process (e.g., fuzzy distribution similarity process) that is depicted in FIG. 7 begins at step/operation 701 when the predictive data analysis computing entity 106 generates a set of L cross-space state correlation graph data objects for the two discrete likelihood model. In some embodiments, a cross-space state correlation graph data object is a graph that is associated with two discrete likelihood models and that comprises: (i) a set of first-model nodes each associated with an output state in the output state space for the first discrete likelihood model, (ii) a set of second-model nodes each associated with an output state in the output state space for the second discrete likelihood model, and (iii) for each node pair that comprises a first-model node and a second-model node, a cross-node link indicator that indicates whether a pairwise neighborhood score for the output state of the first-model node in the node pair and the output state of the second-model node in the node pair satisfies a pairwise neighborhood score condition. In some embodiments, a cross-space state correlation graph data object for two discrete likelihood models comprises: (i) a source node, (ii) a sink node, (iii) a set of N₁ first-model nodes each associated with an output state in the N₁-sized output state space for the first discrete likelihood model, (iv) a set of N₂ second-model nodes each associated with an output state in the N₂-sized output state space for the second discrete likelihood model, (v) a set of N₁ source links each being a graph link/edge from the source node to a respective one of the N₁ first-model nodes, (vi) a set of N₂ sink links each being a graph link/edge from a respective one of the N₂ second-model nodes to the sink mode, and (vii) for each node pair comprising a first-model node and a second-model node and that is associated with an affirmative cross-link indicator (which indicates that the a pairwise neighborhood score for the output state of the first-model node in the node pair and the output state of the second-model node in the node pair satisfies a pairwise neighborhood score condition), a cross-node link/edge from the first-model node in the pair to the second-model node in the node pair. An operational example of a cross-space state correlation graph data object 1300 is depicted in FIG. 13.

For example, when the first discrete likelihood model is a predicted transition likelihood model for a dynamics model component with an N₁-sized per-component output state space and the second discrete likelihood model is an empirical transition likelihood model with an N₂-sized empirical output state subset, then the cross-space state correlation graph data object may be a graph that is associated with at least one of: (i) a source node, (ii) a sink node, (iii) N₁ source links each being a link/edge from the source node to a respective one of the per-component output states in the N₁-sized per-component output state space, (iv) N₂ sink links each being a link/edge from a respective one of the empirical output states in the N₂-sized empirical output state subset, (v) N₁ per-component state nodes each being the node for a respective one of the per-component output states in the N₁-sized per-component output state space, (vi) N₂ empirical state nodes each being the node for a respective one of the empirical output states in the N₂-sized empirical output state space, and (vii) for each node pair that comprises a per-component state node for a per-component output state in the N₁-sized per-component output state space and an empirical state node for an empirical output state in the N₂-sized empirical output state subset, if the pairwise neighborhood score for the per-component output state and the empirical output state space satisfies a pairwise neighborhood score condition, then a cross-node link/edge from the per-component state node for the per-component output state to the empirical state node for the empirical output state.

In some embodiments, generating L cross-space state correlation graph data objects is performed based at least in part on a cross-state neighborhood definition model that defines, for each state pair associated with output state spaces of a set of discrete likelihood models, a pairwise neighborhood score that describes whether and/or how much the output state pair are deemed to be neighboring/related output states. For example, when a set of discrete likelihood models correspond to discrete transition likelihood models for a dynamics model of a reinforcement learning machine learning framework, the state pairs may correspond to pairs of reinforcement learning states from the S reinforcement learning states associated with a reinforcement learning environment of the reinforcement learning machine learning frameworks. In the described example, the pairwise neighborhood scores for a state pair may describe whether and/or how much the two reinforcement learning states in the state pair are deemed to be neighboring/related reinforcement learning spaces.

In some embodiments, given two output states (e.g., reinforcement learning states) in a state pair, the state pair is assigned a first (e.g., a lowest) pairwise neighborhood score if the state representations (e.g., state representation vectors) for the two output states are identical. For example, if a state pair comprises a first output state space with the state representation (1, 2, 3) and a second output state space with the state representation (1, 2, 3), then the state pair may be assigned a lowest pairwise neighborhood score, such as a pairwise neighborhood score of one.

In some embodiments, given two output state spaces in a state pair, the state pair is assigned a second (e.g., a second-lowest) pairwise neighborhood score if the state representations for the two output state spaces differ in one value and the difference is by one. For example, if a state pair comprises a first output state space with the state representation (1, 2, 3) and a second output state space with the state representation (1, 1, 3), then the state pair may be assigned a second-lowest pairwise neighborhood score, such as a pairwise neighborhood score of two, as the two state representations differ in one value (i.e., the second value) and the difference is by one (i.e., 2−1=1).

In some embodiments, given two output state spaces in a state pair, the state pair is assigned a third (e.g., a third-lowest) pairwise neighborhood score if the state representations for the two output state spaces differ in two values and the differences are by one. For example, if a state pair comprises a first output state space with the state representation (1, 2, 3) and a second output state space with the state representation (1, 1, 2), then the state pair may be assigned a third-lowest pairwise neighborhood score, such as a pairwise neighborhood score of three, as the two state representations differ in two values (i.e., the second value and the third value) and the differences are by one (i.e., 2−1=1 for the second value and 3−2 for the third value).

In some embodiments, given two output state spaces in a state pair, the state pair is assigned a fourth (e.g., a fourth-lowest) pairwise neighborhood score if the state representations for the two output state spaces differ in one or two values by two. For example, if a state pair comprises a first output state space with the state representation (3, 2, 3) and a second output state space with the state representation (1, 2, 3), then the state pair may be assigned a fourth-lowest pairwise neighborhood score, such as a pairwise neighborhood score of four, as the two state representations differ in one value (i.e., the first value) and the difference is by two (i.e., 3−1=2). As another example, if a state pair comprises a first output state space with the state representation (3, 4, 3) and a second output state space with the state representation (1, 2, 3), then the state pair may be assigned a fourth-lowest pairwise neighborhood score, such as a pairwise neighborhood score of four, as the two state representations differ in two values (i.e., the first value and the second value) and the differences are by two (i.e., 3−1=2 for the first value and 4−2=2 for the second value).

In some embodiments, the cross-state neighborhood definition model defines a pairwise neighborhood score for each state pair (e.g., each state pair associated with two reinforcement learning states of a reinforcement learning environment for a reinforcement learning machine learning framework). In some embodiments, the cross-state neighborhood definition model defines a set of state pairs that have a non-zero pairwise neighborhood score. In some embodiments, the pairwise neighborhood score is a binary/Boolean variable, while in other embodiments the pairwise neighborhood score can have three or more values.

As described above, in some embodiments, when a state pair is associated with a pairwise neighborhood score that satisfies a pairwise neighborhood score condition (e.g., there is a fuzzy match), then the node pair corresponding to the state nodes for the state pair is assigned an affirmative cross-node link indicator, which means that the cross-space state correlation graph data object that is associated with the pairwise neighborhood score condition includes a cross-node link/edge between the node pair. For example, if the pairwise neighborhood score condition is satisfied when the pairwise neighborhood score is one, then cross-space state correlation graph data object that is associated with the pairwise neighborhood score condition includes cross-node links/edges only between node pairs whose respective state pairs have a pairwise neighborhood score of one (e.g., whose state representation pairs are identical). As another example, if the pairwise neighborhood score condition is satisfied when the pairwise neighborhood score is one or two, then cross-space state correlation graph data object that is associated with the pairwise neighborhood score condition includes cross-node links/edges only between node pairs whose respective state pairs have a pairwise neighborhood score of one or two (e.g., whose state representation pairs are identical or differ in one value by one).

In some embodiments, L pairwise neighborhood score conditions are defined. In some of those embodiments, L cross-space state correlation graph data objects are generated, with each cross-space state correlation graph data object being associated with a respective pairwise neighborhood score condition of the L pairwise neighborhood score conditions. In some of the noted embodiments, the L cross-space state correlation graph data objects are identical except that they have different cross-node links/edges, with the set of cross-node links/edges of each cross-space state correlation graph data object being selected based at least in part on the node pairs whose respective state pairs satisfy the respective pairwise neighborhood score condition for the cross-space state correlation graph data object.

For example, consider an exemplary environment characterized by: (i) a predicted transition likelihood model for a dynamics model component whose respective per-component output state space comprises the reinforcement learning state with the state representation (1, 2, 3), the reinforcement learning state with the state representation (1, 3, 3), and the reinforcement learning state with the state representation (4, 2, 3), (ii) an empirical transition likelihood model whose respective empirical output state space comprises the reinforcement learning state with the state representation (1, 2, 3), the reinforcement learning state with the state representation (1, 3, 4), and the reinforcement learning state with the state representation (4, 4, 3), (iii) a first pairwise neighborhood score condition that is satisfied when the pairwise neighborhood score for a given state pair is one, and (iv) a second pairwise neighborhood score condition that is satisfied when the pairwise neighborhood score for the given state pair is one or two. In this example, for the first pairwise neighborhood score condition, a first cross-space state correlation graph data object may be generated that may include: (i) a source node, (ii) a sink node, (iii) source links from the source node to each of the reinforcement learning state with the state representation (1, 2, 3), the reinforcement learning state with the state representation (1, 3, 3), and the reinforcement learning state with the state representation (4, 2, 3), (iv) sink links from each of the reinforcement learning state with the state representation (1, 2, 3), the reinforcement learning state with the state representation (1, 3, 4), and the reinforcement learning state with the state representation (4, 4, 3) to the sink node, and (v) a sole cross-node link/edge from the reinforcement learning state with the state representation (1, 2, 3) and the reinforcement learning state with the state representation (1, 2, 3), as the two reinforcement learning states have identical state representations and thus can be assigned a pairwise neighborhood score of one in accordance with the exemplary scoring logic described above. Moreover, given the described example, for the second pairwise neighborhood score condition, a second cross-space state correlation graph data object may be generated that may include: (i) a source node, (ii) a sink node, (iii) source links from the source node to each of the reinforcement learning state with the state representation (1, 2, 3), the reinforcement learning state with the state representation (1, 3, 3), and the reinforcement learning state with the state representation (4, 2, 3), (iv) sink links from each of the reinforcement learning state with the state representation (1, 2, 3), the reinforcement learning state with the state representation (1, 3, 4), and the reinforcement learning state with the state representation (4, 4, 3) to the sink node, (iv) a first cross-node link/edge from the reinforcement learning state with the state representation (1, 2, 3) and the reinforcement learning state with the state representation (1, 2, 3), as the two reinforcement learning states have identical state representations and thus can be assigned a pairwise neighborhood score of one in accordance with the exemplary scoring logic described above, and (v) a second cross-node link/edge from the reinforcement learning state with the state representation (1, 3, 3) and the reinforcement learning state with the state representation (1, 3, 4), as the two state representations differ in one value and by one, and thus can be assigned a pairwise neighborhood score of two in accordance with the exemplary scoring logic described above.

As the above example illustrates, in some embodiments, each pairwise neighborhood score condition of L pairwise neighborhood score condition is associated with a hierarchical neighborhood definition level of L hierarchical neighborhood definition levels defined by a hierarchical neighborhood definition level scheme, where each hierarchical neighborhood definition level is associated with a respective pairwise neighborhood score condition and is used to generate a resulting cross-space state correlation graph data object based at least in part on the respective pairwise neighborhood score condition, and the hierarchical neighborhood definition level defines the plurality of hierarchical neighborhood definition levels in a manner such that the respective pairwise neighborhood score condition for a particular neighborhood definition level comprises each respective pairwise neighborhood score condition for any lower-level neighborhood definition levels of the particular neighborhood definition level.

For example, in some embodiments, the hierarchical neighborhood definition level scheme is associated with a lowest-level hierarchical neighborhood definition level that is associated with a lowest-level pairwise neighborhood score condition, where the lowest-level pairwise neighborhood score condition is satisfied when the pairwise neighborhood score for a state pair of a respective node pair is a lowest pairwise neighborhood score. In some embodiments, the lowest-level pairwise neighborhood score condition is satisfied when a given node pair is associated with a state pair that comprises two identical defined reinforcement learning states.

As another example, in some embodiments, the hierarchical neighborhood definition level scheme is associated with a second-lowest-level hierarchical neighborhood definition level that is associated with a second-lowest-level pairwise neighborhood score condition, where the second-lowest-level pairwise neighborhood score condition is satisfied when the pairwise neighborhood score for a state pair of a respective node pair is a lowest pairwise neighborhood score or a second-lowest pairwise neighborhood score. In some embodiments, the second-lowest-level pairwise neighborhood score condition is satisfied when a given node pair is associated with a state pair that comprises either: (i) two identical defined reinforcement learning states, or (ii) two defined reinforcement learning states whose respective state representations differ in one value by one.

As yet another example, in some embodiments, the hierarchical neighborhood definition level scheme is associated with a third-lowest-level hierarchical neighborhood definition level that is associated with a third-lowest-level pairwise neighborhood score condition, where the third-lowest-level pairwise neighborhood score condition is satisfied when the pairwise neighborhood score for a state pair of a respective node pair is a lowest pairwise neighborhood score, a second-lowest pairwise neighborhood score, or a third-lowest pairwise neighborhood score. In some embodiments, the third-lowest-level pairwise neighborhood score condition is satisfied when a given node pair is associated with a state pair that comprises either: (i) two identical defined reinforcement learning states, (ii) two defined reinforcement learning states whose respective state representations differ in one value by one, or (iii) two defined reinforcement learning states whose respective state representations differ in two values by one.

As a further example, in some embodiments, the hierarchical neighborhood definition level scheme is associated with a fourth-lowest-level hierarchical neighborhood definition level that is associated with a fourth-lowest-level pairwise neighborhood score condition, where the fourth-lowest-level pairwise neighborhood score condition is satisfied when the pairwise neighborhood score for a state pair of a respective node pair is a lowest pairwise neighborhood score, a second-lowest pairwise neighborhood score, a third-lowest pairwise neighborhood score, or a fourth-lowest pairwise neighborhood score. In some embodiments, the fourth-lowest-level pairwise neighborhood score condition is satisfied when a given node pair is associated with a state pair that comprises either: (i) two identical defined reinforcement learning states, (ii) two defined reinforcement learning states whose respective state representations differ in one value by one, (iii) two defined reinforcement learning states whose respective state representations differ in two values by one, or (iv) two defined reinforcement learning states whose respective state representations differ in one or two values by two.

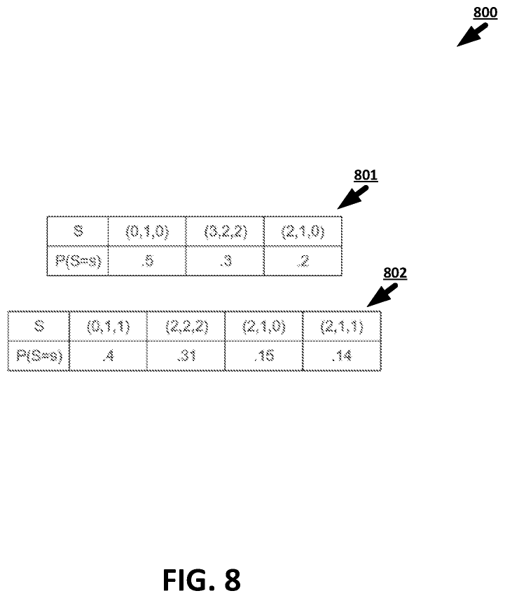

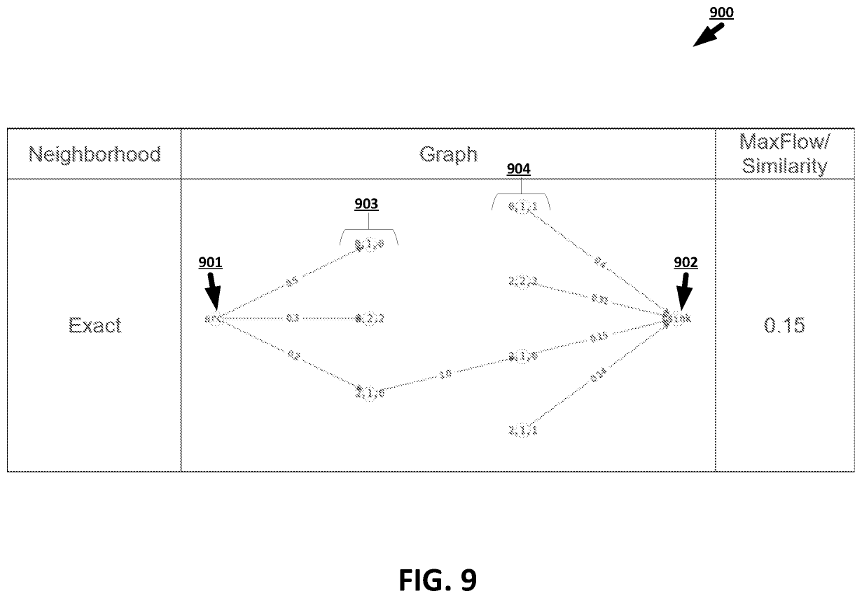

An operational example of generating L=4 cross-space state correlation graph data objects is depicted in FIGS. 8-12. In particular, FIGS. 9-12 depict L=4 cross-space state correlation graph data objects for the predicted transition likelihood model 801 and the empirical transition likelihood model 802 that are depicted in FIG. 8. As depicted in FIG. 8, the predicted transition likelihood model 801 is associated with the per-component output state space {(0, 1, 0), (3, 2, 2), (2, 1, 0)} and describes: a predicted probability/likelihood value of 0.5 for the reinforcement learning state (0, 1, 0), a predicted probability/likelihood value of 0.3 for the reinforcement learning state (3, 2, 2), and a predicted probability/likelihood value of 0.2 for the reinforcement learning state (2, 1, 0). Moreover, as further depicted in FIG. 8, the empirical transition likelihood model 802 is associated with the empirical output state space {(0, 1, 1), (2, 2, 2), (2, 1, 0), and (2, 1, 1)} and describes: an observed probability/likelihood value of 0.4 for the reinforcement learning state (0, 1, 1), an observed probability/likelihood value of 0.31 for the reinforcement learning state (2, 2, 2), an observed probability/likelihood value of 0.15 for the reinforcement learning state (2, 1, 0), and an observed probability/likelihood value of 0.14 for the reinforcement learning state (2, 1, 1).

FIGS. 9-12 provide the operational example of four cross-space state correlation graph data objects generated for the predicted transition likelihood model 801 and the empirical transition likelihood model 802. As depicted in FIGS. 9-12, all four cross-space state correlation graph data objects include a source node 901, a sink node 902, a set of three per-component output state nodes 903 each being associated with a respective one of the reinforcement learning states in the per-component output state space {(0, 1, 0), (3, 2, 2), (2, 1, 0)} for the predicted transition likelihood model 801, a set of four empirical state output state nodes 904 each being associated with a respective one of the reinforcement learning states in the empirical output state space {(0, 1, 1), (2, 2, 2), (2, 1, 0), and (2, 1, 1)} for the empirical transition likelihood model 802, a set of source links each being a link/edge from the source node 901 to a respective one of the three per-component output state nodes 903, and a set of sink nodes each being a link/edge from a respective one of the of four empirical state output state nodes 904 to the sink node 902.

However, the four cross-space state correlation graph data objects in FIGS. 9-12 have different sets of cross-node links/edges. For example, the cross-space state correlation graph data object 900 of FIG. 9 is associated with a pairwise neighborhood score condition that is only satisfied by a given node pair when the state pair for the node pair have identical state representations. Accordingly, the cross-space state correlation graph data objects 900 of FIG. 9 comprises only cross-node link/edge: between the reinforcement learning state (2, 2, 2) in the per-component output state space of the predicted transition likelihood model 801 and the reinforcement learning state (2, 2, 2) in the empirical output state space of the empirical transition likelihood model 802, as the two reinforcement learning states are indeed one reinforcement learning states with an identical state representation.

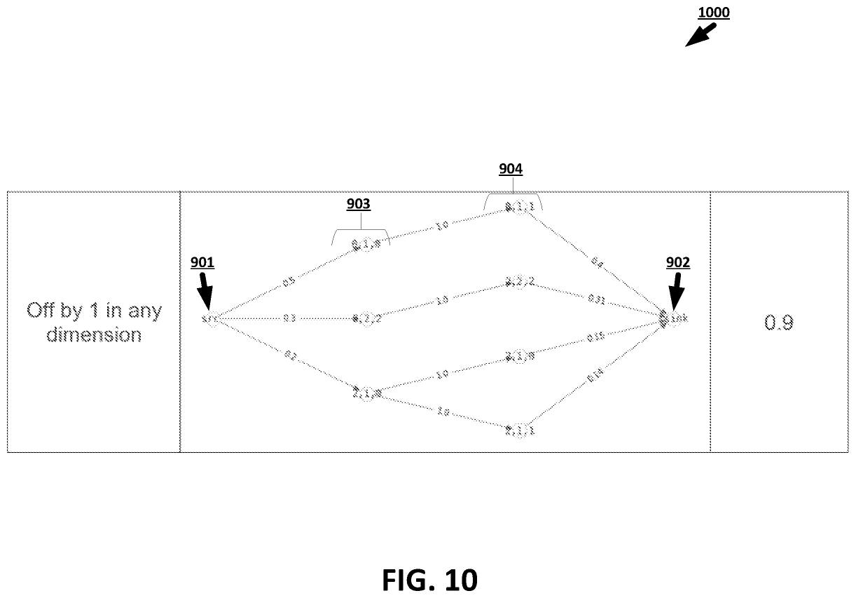

As another example, the cross-space state correlation graph data object 1000 of FIG. 10 is associated with a pairwise neighborhood score condition that is only satisfied when a given node pair is associated with a state pair that comprises either: (i) two identical defined reinforcement learning states, or (ii) two defined reinforcement learning states whose respective state representations differ in one value by one. Accordingly, the cross-space state correlation graph data object 1000 of FIG. 10 comprises, in addition to the cross-node link/edge between the reinforcement learning state (2, 2, 2) in the per-component output state space of the predicted transition likelihood model 801 and the reinforcement learning state (2, 2, 2) in the empirical output state space of the empirical transition likelihood model 802: (i) a cross-node link/edge between the reinforcement learning state (0, 1, 0) in the per-component output state space of the predicted transition likelihood model 801 and the reinforcement learning state (0, 1, 1) in the empirical output state space of the empirical transition likelihood model 802, (ii) a cross-node link/edge between the reinforcement learning state (3, 2, 2) in the per-component output state space of the predicted transition likelihood model 801 and the reinforcement learning state (2, 2, 2) in the empirical output state space of the empirical transition likelihood model 802, and (iii) a cross-node link/edge between the reinforcement learning state (2, 1, 0) in the per-component output state space of the predicted transition likelihood model 801 and the reinforcement learning state (2, 1, 1) in the empirical output state space of the empirical transition likelihood model 802.

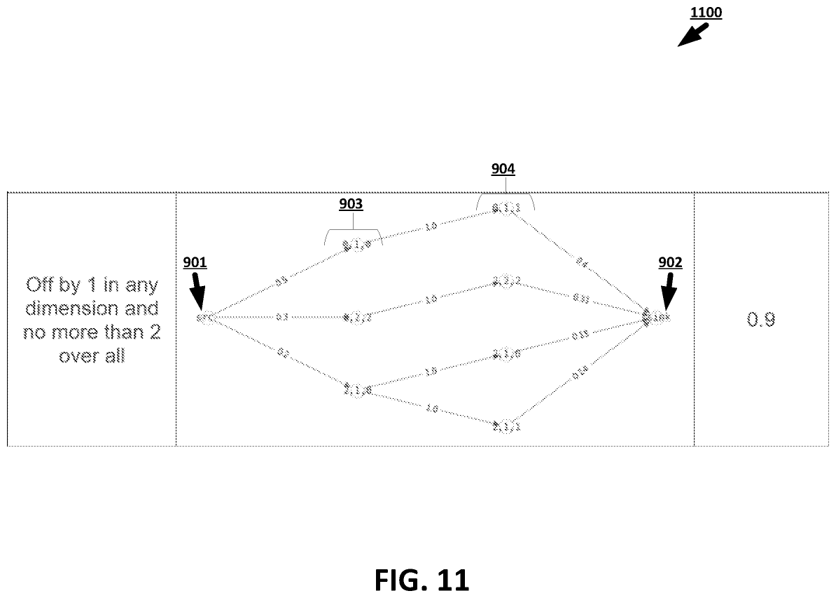

As yet another example, the cross-space state correlation graph data object 1100 of FIG. 11 is associated with a pairwise neighborhood score condition that is only satisfied when a given node pair is associated with a state pair that comprises either: (i) two identical defined reinforcement learning states, (ii) two defined reinforcement learning states whose respective state representations differ in one value by one, or (iii) two defined reinforcement learning states whose respective state representations differ in two values by one. In the operational example of FIGS. 9-12, no node pair satisfies (iii). Accordingly, the cross-space state correlation graph data object 1100 of FIG. 11 is identical to the cross-space state correlation graph data object 1000 of FIG. 10, despite having a different and broader pairwise neighborhood score condition. Thus, the cross-space state correlation graph data object 1100 of FIG. 11 comprises: (i) the cross-node link/edge between the reinforcement learning state (2, 2, 2) in the per-component output state space of the predicted transition likelihood model 801 and the reinforcement learning state (2, 2, 2) in the empirical output state space of the empirical transition likelihood model 802, (ii) a cross-node link/edge between the reinforcement learning state (0, 1, 0) in the per-component output state space of the predicted transition likelihood model 801 and the reinforcement learning state (0, 1, 1) in the empirical output state space of the empirical transition likelihood model 802, (iii) a cross-node link/edge between the reinforcement learning state (3, 2, 2) in the per-component output state space of the predicted transition likelihood model 801 and the reinforcement learning state (2, 2, 2) in the empirical output state space of the empirical transition likelihood model 802, and (iv) a cross-node link/edge between the reinforcement learning state (2, 1, 0) in the per-component output state space of the predicted transition likelihood model 801 and the reinforcement learning state (2, 1, 1) in the empirical output state space of the empirical transition likelihood model 802.

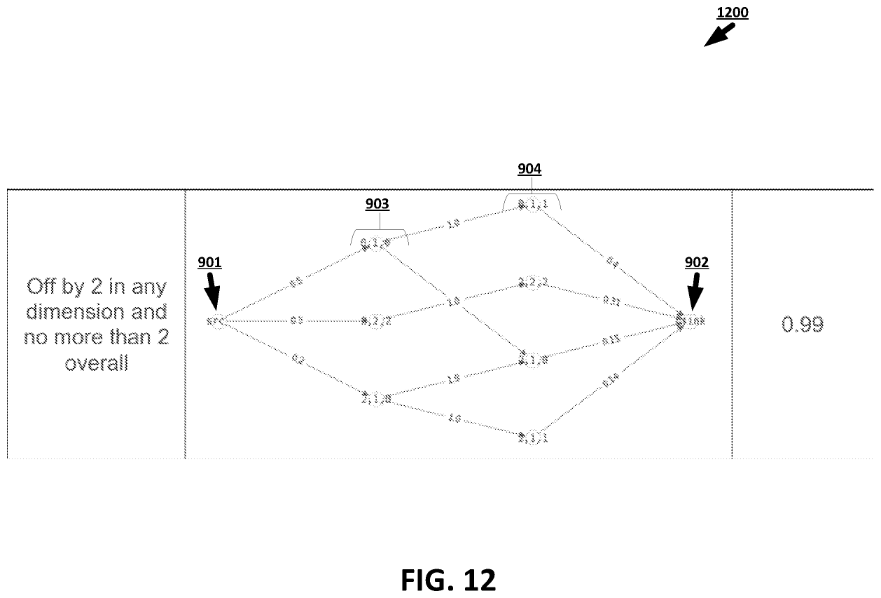

As a further example, the cross-space state correlation graph data object 1200 of FIG. 12 is associated with a pairwise neighborhood score condition that is only satisfied when a given node pair is associated with a state pair that comprises either: (i) two identical defined reinforcement learning states, (ii) two defined reinforcement learning states whose respective state representations differ in one value by one, (iii) two defined reinforcement learning states whose respective state representations differ in two values by one, or (iv) two defined reinforcement learning states whose respective state representations differ in one or two values by two. Accordingly, the cross-space state correlation graph data object 1200 of FIG. 12 comprises: (i) the cross-node link/edge between the reinforcement learning state (2, 2, 2) in the per-component output state space of the predicted transition likelihood model 801 and the reinforcement learning state (2, 2, 2) in the empirical output state space of the empirical transition likelihood model 802, (ii) a cross-node link/edge between the reinforcement learning state (0, 1, 0) in the per-component output state space of the predicted transition likelihood model 801 and the reinforcement learning state (0, 1, 1) in the empirical output state space of the empirical transition likelihood model 802, (iii) a cross-node link/edge between the reinforcement learning state (3, 2, 2) in the per-component output state space of the predicted transition likelihood model 801 and the reinforcement learning state (2, 2, 2) in the empirical output state space of the empirical transition likelihood model 802, (iv) a cross-node link/edge between the reinforcement learning state (2, 1, 0) in the per-component output state space of the predicted transition likelihood model 801 and the reinforcement learning state (2, 1, 1) in the empirical output state space of the empirical transition likelihood model 802, (v) a cross-node link/edge between the reinforcement learning state (0, 1, 0) in the per-component output state space of the predicted transition likelihood model 801 and the reinforcement learning state (2, 1, 0) in the empirical output state space of the empirical transition likelihood model 802.

As depicted in FIGS. 9-12, in some embodiments: (i) each cross-node link is assigned a fixed link/edge weight value, such as fixed link weight value of one, (ii) each source link from the source node to a respective output state (e.g., a respective reinforcement learning state) in the output state space of a first discrete likelihood model (e.g., in the per-component output state space of a predicted transition likelihood model) is assigned a link/edge weight value that is generated based at least in part on the predicted probability/likelihood value for the respective output state as described by the first discrete likelihood model (e.g., that is generated based at least in part on the predicted state transition likelihood measure for the respective output reinforcement learning state as described by the noted predicted transition likelihood model), and (iii) each sink link to the sink node and from a respective output state (e.g., a respective reinforcement learning state) in the output state space of a second discrete likelihood model (e.g., in the empirical output state space of an empirical transition likelihood model) is assigned a link/edge weight value that is generated based at least in part on the predicted probability/likelihood value for the respective output state as described by the second discrete likelihood model (e.g., that is generated based at least in part on the empirical state transition likelihood measure for the respective output reinforcement learning state as described by the noted empirical transition likelihood model).

For example, in the cross-space state correlation graph data objects of FIGS. 9-12: (i) the source link from the source node to the reinforcement learning state (0, 1, 0) has the link weight value of 0.5 that is the predicted probability value for the noted reinforcement learning state as described by the predicted transition likelihood model 801, (ii) the source link from the source node to the reinforcement learning state (3, 2, 2) has the link weight value of 0.3 that is the predicted probability value for the noted reinforcement learning state as described by the predicted transition likelihood model 801, (ii) the source link from the source node to the reinforcement learning state (2, 1, 0) has the link weight value of 0.2 that is the predicted probability value for the noted reinforcement learning state as described by the predicted transition likelihood model 801, (iv) the sink link to the sink node from the reinforcement learning state (0, 1, 1) has the link weight value of 0.4 that is the observed probability value for the noted reinforcement learning state as described by the empirical transition likelihood model 802, (v) the sink link to the sink node from the reinforcement learning state (2, 2, 2) has the link weight value of 0.31 that is the observed probability value for the noted reinforcement learning state as described by the empirical transition likelihood model 802, (vi) the sink link to the sink node from the reinforcement learning state (2, 1, 0) has the link weight value of 0.15 that is the observed probability value for the noted reinforcement learning state as described by the empirical transition likelihood model 802, and (vii) the sink link to the sink node from the reinforcement learning state (2, 1, 1) has the link weight value of 0.14 that is the observed probability value for the noted reinforcement learning state as described by the empirical transition likelihood model 802.

Returning to FIG. 7, once the L cross-space state correlation graph data objects are generated, at step/operation 702, each cross-space state correlation graph data object is scored using a maxflow graph scoring routine to generate a graph score. Accordingly, at step/operation 702, L graph scores are generated, with each graph score being the score for a respective cross-state correlation graph data object of L cross-state correlation graph data objects.

A maxflow graph scoring routine may be configured to process a graph data object that has a source node and a sink node (e.g., a cross-space state correlation graph data object) to generate a maxflow score for the graph data object, where the maxflow score can then be used to generate a graph score for the noted graph data object. In some embodiments, the maxflow graph scoring routine adopts a maxflow score generated by a particular maxflow calculation technique via processing a graph data object as the maxflow score for the graph data object. In some embodiments, the maxflow graph scoring routine adopts a statistical distribution measure (e.g., a mean) of two or more maxflow scores generated by two or more maxflow calculation techniques via processing a graph data object as the maxflow score for the graph data object. Examples of maxflow calculation techniques include techniques that use the Edmond-Karp's algorithm and/or techniques that use the Ford-Fulkerson algorithm.

At step/operation 703, the predictive data analysis computing entity 106 generates the cross-space likelihood similarity measure based at least in part on the L graph scores. In some embodiments, when L=1, the predictive data analysis computing entity 106 adopts the single graph score as the cross-space likelihood similarity measure. In some embodiments, when L>1, the predictive data analysis computing entity 106 combines the L graph scores to generate the cross-space likelihood similarity measure. For example, in some embodiments, the predictive data analysis computing entity 106 generates a weighted combination of the L graph scores based at least in part on graph weights for the corresponding L cross-space state correlation graph data objects used to generate the L graph scores to generate the cross-space likelihood similarity measure.

In some embodiments, generating a cross-space likelihood similarity measure comprises: (i) for each hierarchical neighborhood definition level of L hierarchical neighborhood definition levels defined by a hierarchical neighborhood definition level scheme, generating a graph score by applying the maxflow graph scoring routine to the resulting cross-space state correlation graph data object for the hierarchical neighborhood definition level, and (ii) generating the particular cross-space likelihood similarity measure based at least in part on each graph score. In some embodiments, each hierarchical neighborhood definition level is associated with a level weight, and the particular cross-space likelihood similarity measure is generated based at least in part on each graph score and each level weight. In some embodiments, the cross-space likelihood similarity measure is generated by performing operations of the equation SS=Σᵢ₌₁^{L}wᵢ(SSᵢ−SSᵢ₋₁), where: (i) SS is the cross-space likelihood similarity measure, (ii) i is an index variable that iterates over L hierarchical neighborhood definition levels defined by a hierarchical neighborhood definition level scheme, (iii) SSᵢ is the graph score for the ith hierarchical neighborhood definition level, (iv) wᵢ is the level weight for the ith hierarchical neighborhood definition level, (v) level weights are non-increasing as i increases, and (vi) SSᵢ=0.

In some embodiments, generating a cross-space likelihood similarity measure using the operations of the below code segments:

Code Segment 1

[symbol]

[symbol]

indicates data missing or illegible when filed

Code Segment 2

```
def neighbors(act, pred, dims, tol1=1, toln=2, dtype=np [symbol] ) [symbol]  np.array [symbol]
  act_arr = np.array(act, dtype=dtype)[ [symbol] ,dims]
  pred_arr = np.array(pred, dtype=dtype)[ [symbol] ,dims]
  nbors = list( )
  for n in range(act_arr.shape[ [symbol] ]) [symbol]
    diff = np.abs(act_arr[ [symbol] ] [symbol] pred_arr)
    arr_ind = np. [symbol] (np.logical_and((diff [symbol] ) [symbol] ( [symbol] ) [symbol] , diff.sum( [symbol] ) [symbol] ))
    nbors.append(np.hstack([np. [symbol] (arr_ind.shape,n),arr_ind]))
  return np.concat [symbol] (nbors, [symbol] ) [symbol]
indicates data missing or illegible when filed
```

Code Segment 3

act1 = [((0,1,0),.5),((3,2,2),.3),((2,1,0),.2)]
pred1 = [((0,1,1),.4),((2,2,2),.3 [symbol] ),((2,1,0),.15),((2,1,1),.14)]
flow_model(act1, pred1, tol1=2, toln=2, plot=True,
plot_pr [symbol] dict(figsize=(12, [symbol] )))

[symbol]

indicates data missing or illegible when filed

Accordingly, as described above, various embodiments of the present invention introduce technical advantages related to computational efficiency and storage efficiency of training reinforcement learning models using model-based reinforcement learning approaches. For example, various embodiments of the present invention enable training components of a dynamics model of a reinforcement learning framework using cross-space likelihood similarity measures between predicted transition likelihood models and empirical transition likelihood models even when the two noted likelihood models have distinct distribution supports. This enables using training/empirical observation data to train dynamics model components even when the output state spaces of the dynamics model components are distinct from the output state space of the empirical distributions determined using the training/empirical observation data. In this way, various embodiments of the present invention reduce the amount of training/empirical observation data needed to train reinforcement learning models using model-based reinforcement learning approaches, a result that in turn improves computational efficiency and storage efficiency of training reinforcement learning models using model-based reinforcement learning approaches.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a recommended reinforcement learning action for a current reinforcement learning state that is selected from a set of S defined reinforcement learning states, the computer-implemented method comprising:
generating, using a reinforcement learning machine learning framework, the recommended reinforcement learning action, wherein:
the reinforcement learning machine learning framework is associated with an optimal reinforcement learning policy that is generated using an ensemble dynamics model,
the ensemble dynamics model comprises a plurality of R dynamics model components,
each dynamics model component: (i) is associated with a respective input state of the S defined reinforcement learning states and a respective per-component output state space that describes a per-component output state subset of the S defined reinforcement learning states, (ii) is configured to generate predicted state transition likelihood measures from the respective input state to the respective output state space, and (iii) is generated based at least in part on a cross-space likelihood similarity measure between: (a) a respective predicted transition likelihood model that describes the predicted state transition likelihood measures generated by the dynamics model component with respect to the respective per-component output state space, and (b) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and
each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and
performing one or more prediction-based actions based at least in part on the recommended reinforcement learning action.

2. The computer-implemented method of claim 1, wherein generating the particular cross-space likelihood similarity measure for the particular dynamics model component comprises:
generating a cross-space state correlation graph data object for the particular dynamics model component, wherein the cross-space state correlation graph data object comprises: (i) one or more per-component state nodes each associated with one of the per-component output state subset for the particular dynamics model component, (ii) one or more empirical state nodes each associated with one of the empirical output state space for the respective input state of the particular dynamics model component, (iii) for each node pair comprising a respective per-component state node of the one or more per-component state nodes and a respective empirical state node of the one or more empirical state nodes, a cross-node link indicator that is determined based at least in part on whether the pairwise neighborhood state score for the state pair that comprises the defined reinforcement learning state for the respective per-component state node and the defined reinforcement learning state for the respective empirical state node satisfies a pairwise neighborhood score condition; and
generating, based at least in part on the cross-space state correlation graph data object and using a maxflow graph scoring routine, the particular cross-space likelihood similarity measure.

3. The computer-implemented method of claim 2, wherein:
the cross-space state correlation graph data object is associated with a hierarchical neighborhood definition level of a plurality of hierarchical neighborhood definition levels defined by a hierarchical neighborhood definition level scheme,
each hierarchical neighborhood definition level is associated with a respective pairwise neighborhood score condition and is used to generate a resulting cross-space state correlation graph data object based at least in part on the respective pairwise neighborhood score condition, and
the hierarchical neighborhood definition level defines the plurality of hierarchical neighborhood definition levels in a manner such that the respective pairwise neighborhood score condition for a particular neighborhood definition level comprises each respective pairwise neighborhood score condition for any lower-level neighborhood definition levels of the particular neighborhood definition level.

4. The computer-implemented method of claim 3, wherein generating the particular cross-space likelihood similarity measure comprises:
for each hierarchical neighborhood definition level, generating a graph score by applying the maxflow graph scoring routine to the resulting cross-space state correlation graph data object for the hierarchical neighborhood definition level; and
generating the particular cross-space likelihood similarity measure based at least in part on each graph score.

5. The computer-implemented method of claim 4, wherein:
each hierarchical neighborhood definition level is associated with a level weight, and
the particular cross-space likelihood similarity measure is generated based at least in part on each graph score and each level weight.

6. The computer-implemented method of claim 3, wherein (i) the plurality of hierarchical neighborhood definition levels comprises a lowest-level hierarchical neighborhood definition level whose respective pairwise neighborhood score condition is satisfied when a given node pair is associated with a state pair that comprises two identical defined reinforcement learning states, and (ii) the set of S defined reinforcement learning states comprises at least one of (a) a set of condition-describing states that describes a code for a particular condition and a severity indicator for the particular condition, or (b) a set of utilization-category-describing states that describes a code for a particular utilization element and a status indicator.

7. The computer-implemented method of claim 6, wherein the plurality of hierarchical neighborhood definition levels comprise a second-lowest-level hierarchical neighborhood definition level whose respective pairwise neighborhood score condition is satisfied when a given node pair is associated with a state pair that comprises either: (i) two identical defined reinforcement learning states, or (ii) two defined reinforcement learning states whose respective state representations differ in one value by one.

8. The computer-implemented method of claim 7, wherein the plurality of hierarchical neighborhood definition levels comprise a third-lowest-level hierarchical neighborhood definition level whose respective pairwise neighborhood score condition is satisfied when a given node pair is associated with a state pair that comprises either: (i) two identical defined reinforcement learning states, (ii) two defined reinforcement learning states whose respective state representations differ in one value by one, or (iii) two defined reinforcement learning states whose respective state representations differ in two values by one.

9. The computer-implemented method of claim 8, wherein the plurality of hierarchical neighborhood definition levels comprise a third-lowest-level hierarchical neighborhood definition level whose respective pairwise neighborhood score condition is satisfied when a given node pair is associated with a state pair that comprises either: (i) two identical defined reinforcement learning states, (ii) two defined reinforcement learning states whose respective state representations differ in one value by one, (iii) two defined reinforcement learning states whose respective state representations differ in two values by one, or (iv) two defined reinforcement learning states whose respective state representations differ in one or two values by two.

10. The computer-implemented method of claim 2, wherein the cross-space state correlation graph data object further comprises: (i) a source node, (ii) a sink node, (iii) one or more source links between the source node and the one or more per-component state nodes, and (iv) one or more sink nodes between the sink node and the one or more empirical state nodes.

11. An apparatus for generating a recommended reinforcement learning action for a current reinforcement learning state that is selected from a set of S defined reinforcement learning states, the apparatus comprising at least one processor and at least one memory including program code, the at least one memory and the program code configured to, with the processor, cause the apparatus to at least:
generate, using a reinforcement learning machine learning framework, the recommended reinforcement learning action, wherein:
the reinforcement learning machine learning framework is associated with an optimal reinforcement learning policy that is generated using an ensemble dynamics model,
the ensemble dynamics model comprises a plurality of R dynamics model components,
each dynamics model component: (i) is associated with a respective input state of the S defined reinforcement learning states and a respective per-component output state space that describes a per-component output state subset of the S defined reinforcement learning states, (ii) is configured to generate predicted state transition likelihood measures from the respective input state to the respective output state space, and (iii) is generated based at least in part on a cross-space likelihood similarity measure between: (a) a respective predicted transition likelihood model that describes the predicted state transition likelihood measures generated by the dynamics model component with respect to the respective per-component output state space, and (b) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and
each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and
perform one or more prediction-based actions based at least in part on the recommended reinforcement learning action.

12. The apparatus of claim 11, wherein generating the particular cross-space likelihood similarity measure for the particular dynamics model component comprises:
generating a cross-space state correlation graph data object for the particular dynamics model component, wherein the cross-space state correlation graph data object comprises: (i) one or more per-component state nodes each associated with one of the per-component output state subset for the particular dynamics model component, (ii) one or more empirical state nodes each associated with one of the empirical output state space for the respective input state of the particular dynamics model component, (iii) for each node pair comprising a respective per-component state node of the one or more per-component state nodes and a respective empirical state node of the one or more empirical state nodes, a cross-node link indicator that is determined based at least in part on whether the pairwise neighborhood state score for the state pair that comprises the defined reinforcement learning state for the respective per-component state node and the defined reinforcement learning state for the respective empirical state node satisfies a pairwise neighborhood score condition; and
generating, based at least in part on the cross-space state correlation graph data object and using a maxflow graph scoring routine, the particular cross-space likelihood similarity measure.

13. The apparatus of claim 12, wherein:
the cross-space state correlation graph data object is associated with a hierarchical neighborhood definition level of a plurality of hierarchical neighborhood definition levels defined by a hierarchical neighborhood definition level scheme,
each hierarchical neighborhood definition level is associated with a respective pairwise neighborhood score condition and is used to generate a resulting cross-space state correlation graph data object based at least in part on the respective pairwise neighborhood score condition, and
the hierarchical neighborhood definition level defines the plurality of hierarchical neighborhood definition levels in a manner such that the respective pairwise neighborhood score condition for a particular neighborhood definition level comprises each respective pairwise neighborhood score condition for any lower-level neighborhood definition levels of the particular neighborhood definition level.

14. The apparatus of claim 13, wherein generating the particular cross-space likelihood similarity measure comprises:
for each hierarchical neighborhood definition level, generating a graph score by applying the maxflow graph scoring routine to the resulting cross-space state correlation graph data object for the hierarchical neighborhood definition level; and
generating the particular cross-space likelihood similarity measure based at least in part on each graph score.

15. The apparatus of claim 14, wherein:
each hierarchical neighborhood definition level is associated with a level weight, and
the particular cross-space likelihood similarity measure is generated based at least in part on each graph score and each level weight.

16. The apparatus of claim 13, wherein (i) the plurality of hierarchical neighborhood definition levels comprises a lowest-level hierarchical neighborhood definition level whose respective pairwise neighborhood score condition is satisfied when a given node pair is associated with a state pair that comprises two identical defined reinforcement learning states, and (ii) the set of S defined reinforcement learning states comprises at least one of (a) a set of condition-describing states that describes a code for a particular condition and a severity indicator for the particular condition, or (b) a set of utilization-category-describing states that describes a code for a particular utilization element and a status indicator.

17. The apparatus of claim 16, wherein the plurality of hierarchical neighborhood definition levels comprises a second-lowest-level hierarchical neighborhood definition level whose respective pairwise neighborhood score condition is satisfied when a given node pair is associated with a state pair that comprises either: (i) two identical defined reinforcement learning states, or (ii) two defined reinforcement learning states whose respective state representations differ in one value by one.

18. The apparatus of claim 17, wherein the plurality of hierarchical neighborhood definition levels comprise a third-lowest-level hierarchical neighborhood definition level whose respective pairwise neighborhood score condition is satisfied when a given node pair is associated with a state pair that comprises either: (i) two identical defined reinforcement learning states, (ii) two defined reinforcement learning states whose respective state representations differ in one value by one, or (iii) two defined reinforcement learning states whose respective state representations differ in two values by one.

19. The apparatus of claim 18, wherein the plurality of hierarchical neighborhood definition levels comprise a third-lowest-level hierarchical neighborhood definition level whose respective pairwise neighborhood score condition is satisfied when a given node pair is associated with a state pair that comprises either: (i) two identical defined reinforcement learning states, (ii) two defined reinforcement learning states whose respective state representations differ in one value by one, (iii) two defined reinforcement learning states whose respective state representations differ in two values by one, or (iv) two defined reinforcement learning states whose respective state representations differ in one or two values by two.

20. A computer program product for generating a recommended reinforcement learning action for a current reinforcement learning state that is selected from a set of S defined reinforcement learning states, the computer program product comprising at least one non-transitory computer-readable storage medium having computer-readable program code portions stored therein, the computer-readable program code portions configured to:
generate, using a reinforcement learning machine learning framework, the recommended reinforcement learning action, wherein:
the reinforcement learning machine learning framework is associated with an optimal reinforcement learning policy that is generated using an ensemble dynamics model,
the ensemble dynamics model comprises a plurality of R dynamics model components,
each dynamics model component: (i) is associated with a respective input state of the S defined reinforcement learning states and a respective per-component output state space that describes a per-component output state subset of the S defined reinforcement learning states, (ii) is configured to generate predicted state transition likelihood measures from the respective input state to the respective output state space, and (iii) is generated based at least in part on a cross-space likelihood similarity measure between: (a) a respective predicted transition likelihood model that describes the predicted state transition likelihood measures generated by the dynamics model component with respect to the respective per-component output state space, and (b) an empirical transition likelihood model that describes empirical state transition likelihood measures from the respective input state to an empirical output state space describing an empirical output state subset of the S defined reinforcement learning states for the respective input state as computed in accordance with empirical observation data collected from a respective reinforcement learning environment, and
each particular cross-space likelihood similarity measure for a particular dynamics model component is generated based at least in part on a cross-state neighborhood definition model that describes, for each reinforcement learning state pair that are selected from the S defined reinforcement learning states, a pairwise neighborhood score; and
perform one or more prediction-based actions based at least in part on the recommended reinforcement learning action.
